(19) United States
(12) Patent Application Publication
(10) Pub. No.: US 2007/0201632 A1
(43) Pub. Date: Aug. 30, 2007

(54) Apparatus, method and computer program product providing a mimo receiver

(76) Inventor: Dumitru Mihai Ionescu, San Diego, CA (US)

Correspondence Address: HARRINGTON & SMITH, PC, 4 RESEARCH DRIVE, SHELTON, CT, 06484-6212, US

(21) Appl. No.: 11/707,532

(22) Filed: Feb. 16, 2007

Related U.S. Application Data
(60) Provisional application No. 60/774,436, filed on Feb. 17, 2006.

(51) Int. Cl. H04M 1/64

(52) U.S. Cl. 379/88.01

(57) ABSTRACT

Disclosed is a method, computer program product and an apparatus providing a novel multiple input/multiple output (MIMO) receiver. The method includes receiving a plurality of signals through a plurality of antennas, the plurality of signals being modulated with a space-time lattice code; removing an effect of a channel matrix from the received signals to provide an equalized received signal; and lattice detecting the equalized received signal based on a Tanner graph representation of the lattice. The Tanner graph representation is one where lattice points inside a shaping region of interest are partitioned into a plurality of subgroups, where each subgroup includes a plurality of different lattice points labeled by an Abelian group block codeword, and where lattice detecting operates on the subgroups. The labels of all subgroups form an Abelian block code represented by the Tanner graph, and lattice detecting further includes performing belief propagation on a corresponding non-binary label Tanner graph to yield a total a posterior probability (APP) and extrinsic APPs of the labels and their coordinates, and obtaining APPs of individual lattice points.

### CLAIM OF PRIORITY FROM COPENDING PROVISIONAL PATENT APPLICATION

This patent application claims priority under 35 U.S.C. §119(e) from Provisional Patent Application No. 60/774,436, filed Feb. 17, 2006, the disclosure of which is incorporated by reference herein in its entirety.

### TECHNICAL FIELD

The exemplary and non-limiting embodiments of this invention relate generally to wireless communications systems, methods, devices and computer programs and, more specifically, relate to multiple input, multiple output (MIMO) wireless communications systems.

### BACKGROUND

The following abbreviations that may appear in the description are defined as follows:

| | |
|---|---|
| AWGN | additive white Gaussian noise |
| APP | a posterior probability |
| MIMO | multiple-input multiple-output |
| MISO | multiple-input single-output |
| SISO | single-input single-output |
| BP | belief propagation |
| SNR | signal-to-noise ratio |
| SAP | serial-to-parallel |
| QF | quasistatic fading |
| IF | independent fading |
| FIR | finite impulse response |
| E-UTRAN | evolved universal terrestrial radio access network |
| OFDM | orthogonal frequency division multiplexing |
| WCDMA | wideband code division multiple access |
| BICM | bit interleaved coded modulation |
| CM | coded modulation |
| LDPC | low density parity check |
| ML | maximum likelihood |
| r.v. | random variable |
| QAM | quadrature amplitude modulation |
| QPSK | quadrature phase shift keying |

The use of an efficient detection method is important in order to accommodate multiple antenna transmissions and/or high order constellations. In such cases, detection by the use of an exhaustive search is prohibitive due to the large number of valid signal combinations across multiple transmit antennas (Cartesian product of individual antenna constellations). A reduced search method, that can nonetheless perform very close to optimal (maximum likelihood or ML) detection, will be required for future generations of wireless systems (cellular and non-cellular). In addition, it would be desirable to have available soft information from the detector in order to improve the performance of a decoder, or to enable iterations between detection and decoding. Further, modularization is desirable, as is any simplification over traditional algorithms, such as sphere decoders.

Most good signal constellations exhibit a lattice structure, which can be used to greatly simplify the search. Sphere detectors (as well as decoders) have been developed primarily in response to the need to alleviate the complexity of ML estimation for a large number of hypotheses. Since the underlying problem is a search, any complexity reduction would need to implement a reduced search procedure. Traditionally, the result of a reduced search algorithm is a hard decision. Upon recognizing the importance of soft information at the detector's output, some researchers began to explore sphere detecting algorithms that are capable of providing a soft information output.

A hard decision sphere detector algorithm was based on an algorithm devised by Pohst (M. Pohst, “On the computation of lattice vectors of minimal length, successive minima, and reduced basis with applications”, ACM SIGSAM Bull., vol. 15, pp. 37-44, 1981, and U. Fincke and M. Pohst, “Improved methods for calculating vectors of short length in a lattice, including a complexity analysis”, Math. Comput., vol. 44, pp. 463-471, April 1985), and were described by Viterbo and Boutros (E. Viterbo and J. Boutros, “A universal lattice decoder for fading channels”, IEEE Trans. Inform. Theory, vol. 45, No. 5, pp. 1639-1642, July 1999). An improved algorithm for closest point search in a lattice was proposed by Schnorr and Euchnerr (C. P. Schnorr and M. Euchnerr, “Lattice basis reduction: improved practical algorithms and solving subset sum problems,” Math. Programming, vol. 66, pp. 181-191, April 1994), which starts at the center of the valid range of lattice points, and has better efficiency. Agrell et al. (E. Agrell, T. Eriksson, A. Vardy, and K. Zeger, “Closest point search in lattices”, IEEE Trans. Inform. Theory, vol. 48, No. 2, pp. 2201-2214, August 2002) devised another algorithm that shows a slight gain at a low signal to noise ratio (SNR).

Seeking to obtain a soft information output, Boutros et al. proposed an approach to soft output sphere detecting (J. Boutros, N. Gresset, L. Brunel, and M. Fossorier, “Soft-input soft-output lattice sphere decoder for linear channels”, Proc. IEEE Conf. Globecom '03, pp. 1583-1587, 2003) without resorting to basis conversions (boundaries of search regions are difficult to determine); instead they take advantage of the finite structure of the constellation (finite modulation alphabet).

Other soft information approaches allow for complex non-lattice modulation alphabets, or replace the sphere with a different body, or implement a list (see, for example, S. Baro, J. Hagenauer, and M. Witzke, “Iterative detection of MIMO transmission using a list-sequential (LISS) detector”, IEEE International Conf. Commun., ICC '03, vol. 4, pp. 2653-2657, Anchorage, May 2003; Y. de Jong and T. Willink, “Iterative tree search detection for MIMO wireless systems”, IEEE 56th Vehicular Technology Conf. VTC '02 Proceedings, vol. 2, pp. 1041-1045, September 2002; and B. M. Hochwald and S. ten Brink, “Achieving near-capacity on a multiple-antenna channel”, IEEE Trans. Commun., vol. 51, pp. 389-399, March 2003.)

Regarding the soft-input soft-output lattice sphere detector from J. Boutros et al., it can be noted that it requires three reduced search passes: first a (Schnorr-Euchnerr) reduced sphere detector search is needed to obtain the initial hard decision ML point, a second search pass then enumerates all lattice points in a sphere centered on the newly found ML point, and a third search pass then evaluates the squared distances needed for generating the soft information. This triple-pass strategy to computing a soft-information detector output increases the detector's complexity, especially since in the final pass the Euclidean distances are computed with respect to both the ML point (from the hard decision pass) and the received point.

Current trends in modern and proposed wireless communication systems, such as one known as Evolved Universal Terrestrial Radio Access Network (E-UTRAN), aim at achieving high data rates at relatively low costs, and mandate multi-carrier designs, high spectral efficiencies and MIMO technology.

### SUMMARY

The foregoing and other problems are overcome, and other advantages are realized, through the use of the exemplary embodiments of this invention.

In a first aspect thereof the exemplary embodiments of this invention provide a method that includes receiving a plurality of signals through a plurality of antennas, the plurality of signals being modulated with a space-time lattice code; removing an effect of a channel matrix from the received signals to provide an equalized received signal; and lattice detecting the equalized received signal based on a Tanner graph representation of the lattice.

In another aspect thereof the exemplary embodiments of this invention provide a computer program product that is embodied in a computer readable medium and that includes instructions, the execution of which result in performing operations that comprise: in response to receiving a plurality of signals through a plurality of antennas, the plurality of signals being modulated with a space-time lattice code, removing an effect of a channel matrix from the received signals to provide an equalized received signal; and lattice detecting the equalized received signal based on a Tanner graph representation of the lattice.

In a still further aspect thereof the exemplary embodiments of this invention provide an apparatus that includes an equalizer configured to respond to a plurality of signals received through a plurality of receive antennas to remove an effect of a channel matrix from the received signals to provide an equalized received signal, the plurality of signals being transmitted from a plurality of transmit antennas modulated with a space-time lattice code. The apparatus further includes a detector configured to operate on the equalized received signal in accordance with a Tanner graph representation of the lattice to perform lattice detection and to output soft information concerning real coordinates of complex symbols from modulation constellations used at the plurality of transmit antennas.

In another aspect thereof the exemplary embodiments of this invention provide an integrated circuit that includes an equalizer circuit configured to respond to a plurality of signals received through a plurality of receive antennas to remove an effect of a channel matrix from the received signals to provide an equalized received signal, the plurality of signals being transmitted from a plurality of transmit antennas modulated with a space-time lattice code; and a detector circuit configured to operate on the equalized received signal in accordance with a Tanner graph representation of the lattice to perform lattice detection and to output soft information concerning real coordinates of complex symbols from modulation constellations used at the plurality of transmit antennas.

In a further aspect thereof the exemplary embodiments of this invention provide an apparatus that includes means for equalizing a plurality of signals received through a plurality of receive antennas to remove an effect of a channel matrix from the received signals to provide an equalized received signal, the plurality of signals being transmitted from a plurality of transmit antennas modulated with a space-time lattice code; and means for operating on the equalized received signal in accordance with a Tanner graph representation of the lattice to perform lattice detection and to output soft information concerning real coordinates of complex symbols from modulation constellations used at the plurality of transmit antennas.

### BRIEF DESCRIPTION OF THE DRAWINGS

In the attached Drawing Figures:

FIG. 1 is an example of a Tanner graph.

FIG. 2 illustrates a projection of a point.

FIG. 3 shows a state transition diagram for a Markov process representing a sequence of lattice points.

FIG. 4 is a block diagram of an iterative receiver for a super-orthogonal space-time lattice code in the presence of a coordinate interleaver, in accordance with exemplary embodiments of this invention.

FIG. 5 is a graph that plots FER versus E_{b}/Nₒ for a super-orthogonal space-time lattice code, with MMSE followed by BP.

FIG. 6 is a graph that plots FER versus E_{b}/Nₒ of iterative decoding based on IC-MMSE plus BP for a super-orthogonal space-time lattice code with coordinate interleaver.

FIG. 7 shows a simplified block diagram of one non-limiting embodiment of a MIMO system that is suitable for use in practicing the exemplary embodiments of this invention.

FIG. 8 is a logic flow diagram that is illustrative of a method and/or execution of a computer program product, in accordance with exemplary embodiments of this invention.

### DETAILED DESCRIPTION

The exemplary embodiments of this invention relate in general directly or indirectly to transmit antenna diversity, MIMO systems, lattice constellations, lattice detection and decoding, soft information, sphere decoding, iterative receivers, belief propagation, Tanner graphs, multipath channels, closed loop schemes, channel estimation, orthogonal frequency division multiplexing (OFDM), space-time coding, spatial precoding, spatial redundancy, beamforming, transmission parameter adaptation and multi-carrier systems, as non-limiting examples.

In accordance with the exemplary embodiments of this invention there is provided an efficient detection method that accommodates multiple antenna transmissions with high order signal constellations.

Further in accordance with the exemplary embodiments of this invention there is provided a reduced search method that is capable of performing in a manner that closely approaches optimal (ML) detection, and that is suitable for use in implementing future generations of wireless systems (both cellular and non-cellular).

Further in accordance with the exemplary embodiments of this invention there is provided an ability to output soft information from the detector in order to improve decoder performance and/or to enable iterations between detection and decoding.

Further in accordance with the exemplary embodiments of this invention there is provided a modularization capability. Related to the foregoing, exemplary embodiments of this invention employ belief propagation, and this functionality may be exploited in receiver implementations that include some form of, by example, a Low Density Parity Check (LDPC) decoder, wherein the architecture may be designed so that the belief propagation module is reusable.

Still further in accordance with the exemplary embodiments of this invention there is provided a technique to avoid a step back artifact that is a result of operation of conventional sphere decoders.

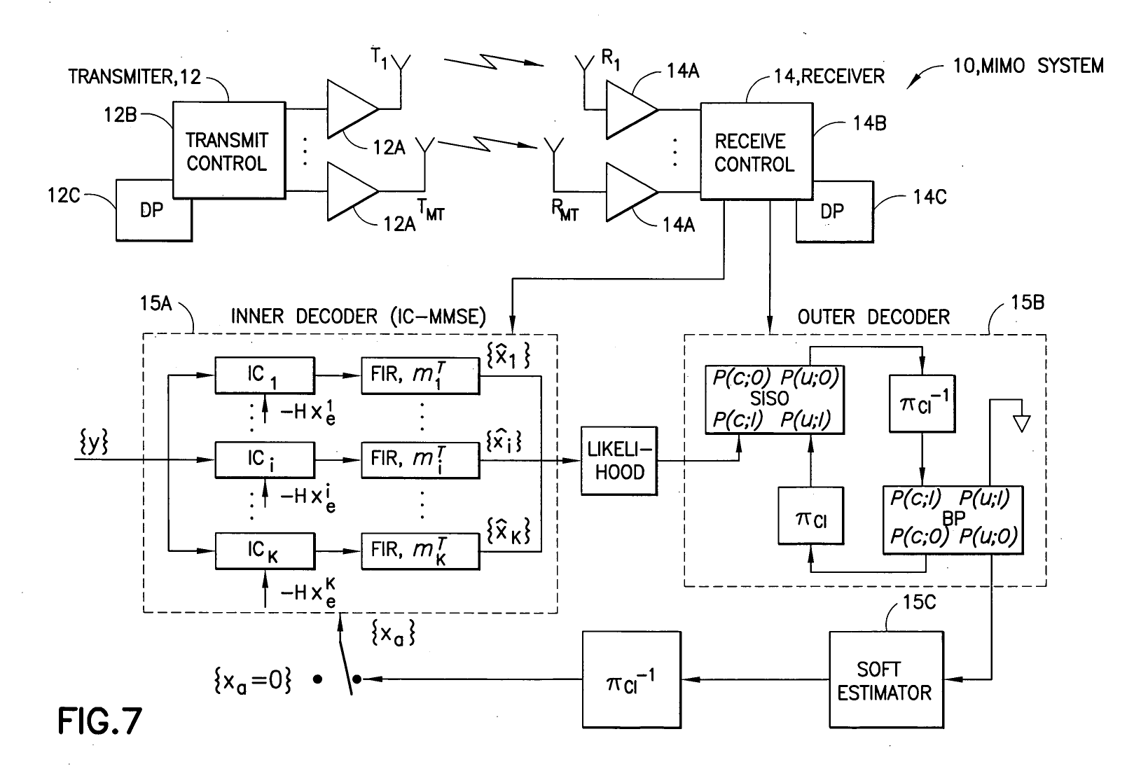

FIG. 7 is a block diagram of an exemplary MIMO system 10 that is suitable for practicing this invention. The MIMO system 10 includes a transmitter 12 and at least one receiver 14. The transmitter 12 has a plurality of transmit (T) antennas (T₁-T_{MT}) and associated transmit amplifiers 12A, and a transmit control function 12B. The receiver 14 has one or more receive (R) antennas (R₁-R_{MR}) and associated receive amplifiers 14A, and a receive control function 14B. In general, the number of transmit antennas may or may not equal the number of receive antennas, and both are preferably greater than one. The transmit control function 12B is assumed to include one or more sources of data, as well as an encoder and modulator, and any other circuitry needed to transmit data, such as packet data (control and/or traffic data packets), to the receiver 14. The receive control function 14B is assumed to include one or more data sinks, as well as a complementary data decoder and demodulator, and any other circuitry needed to receive data, such as packet data, from the transmitter 12.

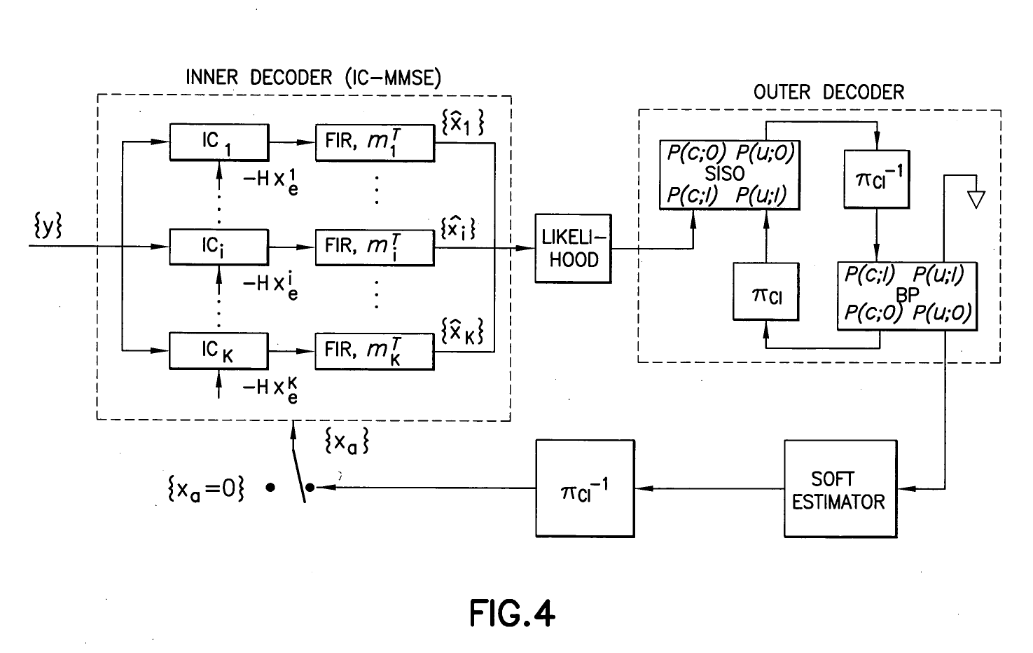

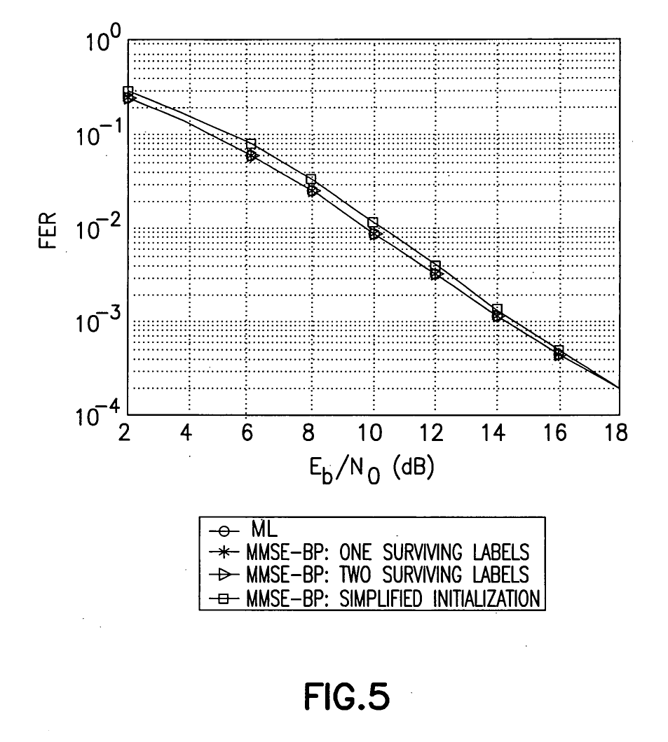

The transmit control function 12B may include at least one data processor (DP) 12C that is operable to execute program code in order to operate as a MIMO transmitter. The receive control function 14B may include at least one data processor (DP) 14C that is operable to execute program code in order to operate as a MIMO receiver, in particular one that operates in accordance with the exemplary embodiments of this invention. Further in this regard the receiver 14 implements a novel iterative receiver, as shown in block diagram form as having, for example, an Inner Decoder (IC-MMSE) 15A, an Outer Decoder 15B and a Soft Estimator 15C, as is also shown in FIG. 4 and described in detail below. The DPs 12C, 14C may be embodied as one or more digital signal processor (DSP) and/or other integrated circuits, or in any form that is suitable for implementing the exemplary embodiments of this invention.

In general, the exemplary embodiments of this invention may be implemented by computer software executable by at least the DP 14C, or by hardware, or by a combination of software and hardware, and also firmware.

Embodiments of the receiver 14 may be realized in, but are not limited to, cellular phones, personal digital assistants (PDAs) having wireless communication capabilities, portable computers having wireless communication capabilities, image capture devices such as digital cameras having wireless communication capabilities, gaming devices having wireless communication capabilities, music storage and playback appliances having wireless communication capabilities, Internet appliances permitting wireless Internet access and browsing, as well as portable units or terminals that incorporate combinations of such functions.

Note that at least one or more of the Inner Decoder (IC-MMSE) 15A, the Outer Decoder 15B and the Soft Estimator 15C may be embodied in one or more integrated circuits.

The exemplary embodiments of this invention beneficially employ an efficient, low-complexity, soft-information detector for MIMO channels and lattice constellations, and are based on, as one example, Tanner graph representations of lattices. Due to the coding gain associated with a lattice, structural relations exist between certain lattice points, which can be associated via an equivalence relation for detection purposes. The detector algorithm in accordance with the exemplary embodiments of this invention is capable of generating both total and extrinsic a posteriori probability at the output of the detector. The step-back artifact (characteristic of traditional sphere decoders) is eliminated. The algorithm applies to general lattices and enables the provisioning of the iterative type of receiver 14.

As non-limiting and exemplary implementations the operation of a novel algorithm was simulated for an uncoded transmission for a super-orthogonal constellation in two scenarios. In a quasi-static (block) fading scenario it was found to achieve ML performance even with one ‘surviving’ label (out of six). In an independent fading scenario, with coordinate (component) interleaving and iterations between equalization and detection, the algorithm was found to perform close to interference-free transmission. The coordinate interleaved scenario was furthermore found to outperform the former scenario, despite the absence of forward error correction coding. In that the presence of one of six labels have been shown to be sufficient in the exemplary implementation, it can be expected that complexity may be reduced to about approximately 17% to 20% of that of the exhaustive (optimal) search, thereby enabling very efficient implementations to be provided.

A more detailed description of the foregoing exemplary aspects of this invention, including the simulations referred to above, is found below.

### Summary of Sphere Decoding Research

Sphere detectors (as well as decoders) arose primarily from the need to alleviate the complexity of ML estimation for a large number of hypotheses. Since the underlying problem is a search, complexity reduction must come from a reduced search. Traditionally, the result of the reduced search algorithm was a hard decision; later, upon recognizing the importance of soft information at the detector's output, researchers began looking at sphere detecting algorithms capable of providing a soft information output.

The hard decision sphere detector algorithm was based on an algorithm devised by Pohst [1], [2], and described by Viterbo and Boutros [4] (there was an earlier paper by Viterbo and Biglieri, in 1993). An improved algorithm for closest point search in a lattice was proposed by Schnorr and Euchnerr [3], which starts at the center of the valid range of lattice points, and has better efficiency. Agrell et al. [31] devised another algorithm that shows a slight gain al low SNR.

Seeking to obtain a soft information output, Boutros et al. proposed a clean, elegant approach to soft output sphere detecting [5] without resorting to basis conversions (boundaries of search regions are difficult to determine); instead they take advantage of the finite structure of the constellation (finite modulation alphabet).

Other soft information approaches allow for complex non-lattice modulation alphabets, or replace the sphere with a different body, or implement a list [7], [6].

Regarding the soft-input soft-output lattice sphere detector from [5], we note that it requires three reduced search passes—first a (Schnorr-Euchnerr) reduced sphere detector search needed to obtain the initial hard decision ML point, second to enumerate all lattice points in a sphere centered on the newly found ML point, and third to evaluate the squared distances needed for generating the soft information. This triple-pass strategy to computing a soft-information detector output increases the detector's complexity—especially since in the last pass Euclidean distances are computed with respect to both the ML point (from the hard decision pass) and the received point.

### I. INTRODUCTION

Multiple input multiple output (MIMO) transmission has emerged as a strong scenario for future high-speed wireless communications due to the large capacity potential of MIMO channels. Space-time codes that exploit both spatial diversity and time diversity have been widely proposed as MIMO modulation in the past decade to achieve reliable transmission.

Recently, the importance of lattice MIMO constellations in constructing space-time lattice codes was recognized by El-Gamal et al. [26] from a diversity-multiplexing tradeoff perspective. Superorthogonal space-time codes—first reported in [18], then in [19], [20], [21], [22] (where they were dubbed ‘superorthogonal’)—are in fact lattice space time codes (see [23, Section III] and Example 2). As lattices, such constellations lend themselves to efficient detection algorithms, e.g. sphere decoding. Classic sphere decoding (see [31] and references therein) use hard decision, and a step-back provision; soft-output versions have been imagined, but rely on a list of important candidates, and retain the step-back provision. In [17], lattice partitioning is used to divide the lattice into a finite number of cosets. Each coset is then labeled by a codeword of a finite Abelian group block code. In [29], a Tanner graph (TG) representation for the label code was developed; this opens an opportunity for using belief propagation on the lattice labels.

The sequel takes a qualitatively different approach to soft output closest point search in lattices, via a form of belief propagation on a lattice. Due to the coding gain associated with a lattice, structural relations exist between certain lattice points, which can be associated via an equivalence relation for detection purposes. The algorithm can generate both total and extrinsic a posteriori probability (APP) at the detector's output. The step-back feature is eliminated. For each channel use, a filter bank for interference cancellation with minimum mean square error (IC-MMSE) is used to remove the channel effects. Then, a reduced-complexity lattice decoder based on TG lattice representation is proposed for computing total APP and extrinsic APP. The capability of calculating the extrinsic APP enables decoding schemes that iterate between detection and decoding. This novel lattice detection algorithm is applied to detecting superorthogonal space-time lattice codes [23] in quasistatic fading, and to a coordinate interleaved [34] scenario. The following notation is adhered to. Vectors are denoted by lowercase bold letters; as denotes the i-th element of vector a. Matrices are denoted by uppercase bold letters. The i-th column vector and the b-th element of a matrix, say A, are denoted by aᵢ and aᵢⱼ, respectively. The superscripts T and H are used to denote transposition and complex conjugated transposition, respectively.

### II. PROBLEM DEFINITION AND SYSTEM MODEL

Complex and real transmission models are described; a general formulation for lattice constellations for MIMO channels is then introduced, followed by two examples pertaining respectively to linear dispersion and superorthogonal codes.

A. Rayleigh Flat Fading MIMO Channels

Consider MIMO wireless transmission with Nₜ transmit antennas and Nᵣ receive antennas in Rayleigh flat fading. The channel coefficients are assumed to be constant over a block of T MIMO channel uses and change independently from block to block. The transmission of each block is then given by
Y=\sqrt{1/Nₜ}SĤ+N (1)
where Yε [symbol] ^{T×N}^{ᵣ}, Ĥε [symbol] ^{N}^{ₛ}^{×N}^{ᵣ}, SεA^{T×N}^{ₛ} and Nε [symbol] ^{T×N}^{ᵣ} are arrays of received signals, channel gain coefficients, transmitted signals and additive noises, respectively. The elements of N are i.i.d. zero-mean complex-valued Gaussian random variables with variance N₀/2 per dimension, i.e., nᵢⱼ˜CN(0, N₀). The channel gain matrix H̅ has elements h̅ᵢⱼ˜CN(0, 1) representing the channel gain coefficients between the i-th transmit antenna and the j-th receive antenna, assumed pairwise independent. The array S describes the transmitted symbols chosen from alphabet A¹; Sᵢⱼε [symbol] is radiated from the j-th transmit antenna during the i-th channel use. By enforcing the power constraint

$$E \{ \frac{1}{T} {‖ S ‖}^{2} \} \leq {N}_{t} , \qquad ( 2 )$$

where ∥•∥ denotes the Euclidean matrix norm and E{•} denotes expectation, the average signal-to-noise (SNR) ratio per receive antenna is 1/N₀.
¹ Different alphabets could be used on different transmit antennas, e.g. Aⱼ could be used on the j-th transmit antenna; the alphabets Aⱼ could differ, for example, when identical constellations are assigned with unequal powers to different transmit antennas. While this general case could be accommodated it is secondary in importance for the purpose of this work.

It is important to note that (1) can accommodate various setups, which include the case T=1 that allows for independent (rather than block) fading. Similarly, the arrays S may have a certain structure, e.g. they may represent space-time code matrices; or, they may simply be arrays of unrelated values obtained after interleaving the real coordinates of structured matrices (Section IV-B) then forming new complex valued arrays out of the scrambled coordinates.

B. Equivalent Real-Valued Transmission Model

Eq. (1) is the receive equation for the transmission of complex valued arrays from Nₜ transmit antennas during T MIMO channel uses. It is also convenient to introduce equivalent real-valued transmission models. To this end, define two isomorphisms from complex domain to real domain, [symbol] : [symbol] ^{M} [symbol] [symbol] ^{2M×1} and φ: [symbol] ^{M×N} [symbol] [symbol] ^{MN×1} as follows:

$$\begin{matrix}ℐ ( a ) {=}^{def} {[ {ℛ ( a )}^{T} {𝒥 ( a )}^{T} ]}^{T} , & ( 3 ) \\ ϕ ( A ) {=}^{def} {[ {ℐ ( {a}_{1} )}^{T} … {ℐ ( {a}_{N} )}^{T} ]}^{T} , & ( 4 )\end{matrix}$$

where aε [symbol] ^{M×1} and A=┌a₁, . . . a_{N}┐ε [symbol] ^{M×N}. The real-valued transmission model that is equivalent to (1) is

$${y}^{c} = {H}^{c} x + {n}^{c} \\ where \\ {y}^{c} {=}^{def} ϕ ( {Y}^{T} ) , {n}^{c} {=}^{def} ϕ ( {N}^{T} ) , x {=}^{def} ϕ ( {S}^{T} ) \qquad ( 5 )$$

cd,(yT),C d a iV(NT) i:-x E(S)
and

$${H}^{c} {=}^{def} {I}_{T} ⊗ ( [ \begin{matrix}ℜ ( {𝔄}^{T} ) & - 𝒯 ( {𝔄}^{T} ) \\ 𝒯 ( {𝔄}^{T} ) & ℜ ( {𝔄}^{T} )\end{matrix} ] ) .$$

Note that H^{c} is a 2NᵣT×2NₜT block-diagonal real channel matrix consisting of T identical diagonal replicas the same 2Nr×2Nₜ matrix (I_{T} is the identity matrix of dimension T and \textcircled{×} denotes the Kronecker product). A similar model has been reported in [26].

In addition, define a new vector y=φ(Y). By definition of φ, it can be seen that the vector y is some permutation π of y^{c}, since y and y^{c} are isomorphisms, via φ, of Y and its transpose Y^{T}. One can obtain y from y^{c} as follows:
y=π(y^{c})=π(H^{c}x+n^{c})=π(H^{c})x+π(n^{c})=Hx+n, (6)
where

$$π ( {H}^{c} ) {=}^{def} H$$

denotes a row permutation of H^{c} by π. The real channel models (6) and (5) are both equivalent to the MIMO model in eq. (1), and can be used interchangeably. In the sequel, (6) will be preferred since it is consistent with the transmission model used in [23]—which is referenced in order to address certain important properties of super-orthogonal space-time codes used, in turn, to demonstrate the algorithm for finding the closest point in a lattice.
C. Space-Time Lattice Codes

An m-dimensional real lattice Λ is a discrete additive subgroup of [symbol] ^{m} defined as Λ={Bu:uε [symbol] ⁿ} where the real matrix B of size m×m is the generator matrix of Λ [26]. A lattice code C(Λ, u₀, R) is the finite subset of the lattice translate Λ+u₀ inside some shaping region R, i.e., C(Λ, u₀, R)={Λ+u₀}∩R, where R is a bounded region of [symbol] ^{m} [26]. A space-time coding scheme with a space-time code matrix set S, such that φ(S^{T})ε [symbol] ⁿ for all SεS, is a lattice space-time code if the m-dimensional image of S via the isomorphism φ is a lattice code C(Λ, u₀, R), i.e., φ({S^{T}})={{Bu:uε [symbol] ⁿ}+u₀}∩R. Many well-known space-time modulation schemes in the literature indeed can be treated as space-time lattice codes. Two important examples of space-time lattice codes are given below.

### EXAMPLE 1

(Linear dispersion codes) A linear dispersion code [27] defines a mapping of a complex vector s=[s₀, s₁, . . . , s_{K-1}]^{T} to a T×Nₜ complex matrix S as follows:

$$S = {\sum }_{l = 0}^{K - 1} ( {s}_{l} {P}_{l} + {s}_{l}^{H} {Q}_{l} ) \qquad ( 7 )$$

where {Pₗ}=ₗ₌₀^{K-1}, {Qₗ}ₜ₌₀^{K-1} are T×Nₜ complex matrices. The linear dispersion code can be further rearranged as

$$S = {\sum }_{l = 0}^{K - 1} ( ℜ ( {s}_{l} ) {\tilde{P}}_{l} + 𝒯 ( {s}_{l} ) {\tilde{Q}}_{l} ) \qquad ( 8 )$$

with \tilde{P}ₗ=Pₗ+Qₗ and \tilde{Q}ₗ=iPₗ−iQₗ. Let χ=I(s); then one can express the linear dispersion code linearly in terms of χ and a set of matrices

$$𝒞 {=}^{def} {\{ {C}_{l} \}}_{l = 0}^{2 K - 1} = \{ {\tilde{P}}_{0} , {\tilde{P}}_{1} , … , {\tilde{P}}_{K - 1} , {\tilde{Q}}_{0} , {\tilde{Q}}_{1} , … , {\tilde{Q}}_{K - 1} \} \\ via \\ S = {\sum }_{i = 0}^{2 K - 1} {χ}_{i} {C}_{i} , \qquad ( 9 )$$

where Cᵢ is the i-th matrix of C. Consequently, the isomorphism of S^{T} via φ, denoted x, is given by

$$x {=}^{def} ϕ ( {S}^{T} ) = {\sum }_{i = 0}^{2 K - 1} {χ}_{i} ϕ ( {C}_{i}^{T} ) = Γχ \\ with \\ Γ = [ ϕ ( {C}_{0}^{T} ) , … , ϕ ( {C}_{2 K - 1}^{T} ) ] . \qquad ( 10 )$$

It is clear from (10) that when the vector χ is proportional to a vector of integers a linear dispersion code is a lattice code with generator matrix Γ; this is the case when s is from a particular modulation constellation such as PAM or QAM. In general, χ is not an integer vector, e.g. when the elements of s are from a PSK constellation. However, if, by construction of the linear dispersion code, s is selected to be from a lattice Λ′ then the points χ are carved from the lattice Λ′ via a shaping region Rε [symbol] ^{m}. That is,
xεΛ′∩ [symbol] . (11)
where Λ′={Bu:uε [symbol] ⁿ} and B is the generator matrix of Λ′, and the linear dispersion code is a lattice space-time code with generator matrix ΓB. One may find different pairs of lattice Λ′ and shaping region R defining the same χs; the choice of Λ′ and R will influence the complexity of the corresponding decoder, as discussed in [29] (unless some basis reduction approach is used to process the generator matrix). The real transmission model becomes
y=HΓBu+n, (12)
and is equivalent to using a lattice space-time code with generator matrix ΓB.

### EXAMPLE 2

(Super orthogonal space-time lattice codes) A super-orthogonal space-time code is constructed [23] by expanding a (generalized) orthogonal design [24], which in turn is obtained as a linear combination of matrices similar to (7), (8), with expansion coefficients derived from a complex vector s; the difference from a linear dispersion code is that the latter matrices verify an additional constraint (see [23, eqs. (2), (3)]). A super-orthogonal space-time construction for T=2, Nₜ=2, and QPSK constellation, having thirty two codematrices, was described in [18], [19], [20], [21], [22]. A generic codematrix S can be expressed as [23]²
² Definition (3) of the isomorphism I from a complex vector to a real vector differs slightly from [23], where it was defined by interlacing the real and imaginary parts; i.e., in [23], if a=┌z₁, . . . , z_{K}┐^{T}ε [symbol] ^{K} then

$$ℐ ( s ) = x {=}^{def} {[ ℛ \{ {z}_{1} \} , 𝒥 \{ {z}_{1} \} , … , ℛ \{ {z}_{κ} \} , 𝒥 \{ {z}_{κ} \} ]}^{T}$$

rather than keeping the real (and imaginary) parts together as done in eq. (3). This is the reason for swapping the second and third matrices in eqs. (15), (16) relative to [23, Sec. III].

$$\begin{matrix}C = \{ [ \begin{matrix}1 & 0 \\ 0 & - 1\end{matrix} ] , [ \begin{matrix}0 & 1 \\ 1 & 0\end{matrix} ] , [ \begin{matrix}i & 0 \\ 0 & i\end{matrix} ] , [ \begin{matrix}0 & - i \\ i & 0\end{matrix} ] \} , & ( 15 ) \\ {C}^{′} = \{ [ \begin{matrix}1 & 0 \\ 0 & 1\end{matrix} ] , [ \begin{matrix}0 & - 1 \\ 1 & 0\end{matrix} ] , [ \begin{matrix}i & 0 \\ 0 & - i\end{matrix} ] , [ \begin{matrix}0 & i \\ i & 0\end{matrix} ] \} . & ( 16 )\end{matrix}$$

above, χ₁ and χ′ₗ (l=0, 1, 2, 3) are either 1, −1, or 0 and the nonzero values are real parts of complex elements from a complex QPSK constellation; the two sets of real coefficients χₗ and χ′ₗ (l=0, 1, 2, 3) are not simultaneously nonzero, i.e. either all χₗs or all χ′ₗs vanish. As discussed in [23], the super-orthogonal matrix codebook is embedded into an 8-dimensional real vector space obtained as the direct sum of two 4-dimensional real vector spaces³. The two sets of matrices C₁ and C′₁ are basis matrices in the component vector spaces that form the direct sum:

$$\begin{matrix}S = {\sum }_{l = 0}^{S} {χ}_{l} {C}_{l} + {\sum }_{l = 0}^{S} {χ}_{l}^{′} {C}_{l}^{′} ; & ( 13 ) \\ {χ}_{l} \neq 0 ⇒ {χ}_{l}^{′} = 0 and {χ}_{l}^{′} \neq 0 ⇒ {χ}_{l} = 0 , ∀ l ; & ( 14 )\end{matrix}$$

The isomorphism of a super-orthogonal space-time codematrix S, denoted by x=φ(S^{T}), is given by

$$x = ϕ ( {S}^{T} ) = {Γχ}_{⊗} \qquad ( 17 )$$

where χ_{⊕}=[χ₀, χ₁, . . . , χ₃, χ₀′, χ₁′, . . . , χ₃′]^{T}=[χ^{T}χ^{/T}]^{T}ε= [symbol] ⁸ is a direct sum of two 4-dimensional vectors, and Γ=[Γ₁Γ₂] is a 8×8 real matrix with

$${Γ}_{1} = [ ϕ ( {C}_{0}^{T} ) , … , ϕ ( {C}_{3}^{T} ) ]$$

$$and$$

$${Γ}_{2} = [ ϕ ( {C}_{0}^{′ T} ) , … , ϕ ( {C}_{3}^{′ T} ) ]$$

and
Γ₂=[φ(C′₀^{T}), . . . ,φ(C′ₛ^{T})]

$$x = {Γχ}_{⊗} = Γ [ \begin{matrix}B & {0}_{4 \times 4} \\ {0}_{4 \times 4} & B\end{matrix} ] u , u = {[ \begin{matrix}{u}_{1} & ⋯ & {u}_{4}\end{matrix} ]}^{T} ∈ {ℤ}^{4}$$

(18)
where B is the generator matrix of the checkerboard lattice D₄, given in (35). Thereby, x can be viewed as being from a lattice with generator matrix

$$Γ [ \begin{matrix}B & {0}_{4 \times 4} \\ {0}_{4 \times 4} & B\end{matrix} ] = [ \begin{matrix}{Γ}_{1} B & {Γ}_{2} B\end{matrix} ] .$$

For a super-orthogonal space-time lattice code the real equivalent transmission model in eq. (6) becomes
y=Hx+n=HΓχ_{⊕}+n=H_{⊕}χ_{⊕}+n=H_{⊕}Bu+n (19
where the second equality is obtained according to (17), and

$${H}_{⊕} {=}^{def} H Γ .$$

Note that in [23] the transmission model for the same super-orthogonal space-time code is (see footnote 2):
y_{⊕}=G_{⊕}χ_{⊕}+n_{⊕}. (20)

It can be verified that

$$[ \begin{matrix}H {Γ}_{1} & {0}_{4 \times 4} \\ {0}_{4 \times 4} & H {Γ}_{2}\end{matrix} ] ∴$$

Furthermore, the matrix G_{⊕} was shown in [23] to be proportional with a unitary matrix, i.e., G_{⊕}G_{⊕}^{H}=αI.

Denote

$${H}_{⊕}^{1} {=}^{def} H {Γ}_{1} and {H}_{⊕}^{2} {=}^{def} H {Γ}_{2}$$

Then, H_{⊕}^{k}, k=1, 2 is unitary up to a scalar, i.e.

$${H}_{⊕}^{{k}^{H}} {H}_{⊕}^{k} = α I , k = 1 , 2. \qquad ( 21 )$$

### III. REDUCED SEARCH SOFT-OUTPUT DETECTOR FOR CLOSEST POINT SEARCH IN LATTICES

While lumping a channel matrix with some (equivalent) generator matrix—as in (19)—might be tempting, the new lattice having generator matrix HΓ or HΓB may have labels with very large label coordinate alphabets (see Section III-B, [29]) for random H—unless some form of basis reduction can be devised. It is more straightforward to illustrate the concept by removing the effect of the channel matrix H via some equalization step, then dealing with the underlying lattice separately. This is the approach taken in the sequel.

A novel soft-information detection algorithm for lattice space-time constellations is introduced below. Detection is performed in two stages: linear minimum mean square error (LMMSE) filtering, and belief propagation (BP) on a lattice. In the first stage, a finite impulse response (FIR) LMMSE filter bank is used to remove the effect of the channel; the lattice redundancy is subsequently exploited by a novel lattice detector based on a Tanner graph representation of the lattice.

A. MMSE Soft Equalizer with Interference Cancellation

The equivalent real transmission model is given in (6). The goal of the MMSE soft equalizer is to remove the effect of the channel H, and provide a soft estimate of each component xᵢ of x so as to minimize the interference due to other coordinates

$${\{ {x}_{l} \}}_{l = 1 , l \neq i}^{2 N , T} ,$$

and to noise n. For the i-th branch the soft estimate denoted as \hat{x}ᵢ is given by
\hat{x}ᵢ=mᵢ^{T}y (22)
with the i-th FIR filter mᵢ being

$${m}_{i} = arg {min}_{m ∈ {R}^{2 {N}_{t} T \times 1}} E \{ {‖ {x}_{i} - {m}^{T} y ‖}^{2} \} \qquad ( 23 )$$

subject to the unit power constraint
mᵢ^{T}hᵢ=1. (24)

This power constraint mitigates the attenuation effect on the desired signal due to the filtering. The optimal solution is [28]

$${m}_{i} = {m}_{i}^{c} + \frac{{a}_{i}}{{h}_{i}^{T} {R}^{- 1} {h}_{i}} {R}^{- 1} {h}_{i} \qquad ( 25 )$$

where

$$R = \frac{P}{2 {N}_{t}} {HH}^{H} + \frac{{N}_{0}}{2} I$$

is the covariance matrix of

$$y , {m}_{i}^{c} = \frac{P}{2 {N}_{t}} {R}^{- 1} {h}_{i}$$

is the optimal solution for (23) without power constraint, and as αᵢ=1−mᵢ^{c}hᵢ. The MSE

$${σ}_{i}^{2} = E \{ {‖ {x}_{i} - {m}_{i}^{T} y ‖}^{2} \}$$

of the i-th branch is

$${σ}_{i}^{2} = \frac{P}{2 {N}_{t}} - {( {m}_{i}^{c} )}^{T} {Rm}_{i}^{c} + \frac{{a}_{i}}{{h}_{i}^{T} {R}^{- 1} {h}_{i}} \qquad ( 26 )$$

If detection and decoding can be performed iteratively, then soft information about x can be fed back from the FEC decoder and made available to the filter bank in the form of probabilities of valid realizations of transmitted vectors x, or its elements xᵢ; i.e. either at the vector level,
x,{Pr(x=φ(C^{T}))⁻|φ(C^{T}εC(Λ,u₀, [symbol] )},
or at the coordinate level—e.g. in the case when coordinate interleaving [34] is used to scramble the coordinates of several vectors x prior to transmission. In the latter case the structure present in the different multidimensional lattice points is destroyed during transmission through the channel; not only does this mean that the coordinate probabilities supplied by the decoder have to be unscrambled before being fed back to the LMMSE filter for interference cancellation (IC—see FIG. 4), but the performance can be improved (over the non-interleaved scenario) even in an uncoded system (see Section IV-B).

An iterative receiver aims at iteratively canceling the interference prior to filtering by forming as soft interference estimator in one of two ways:

1) Vector level feedback:
x_{IC}═Σ_{φ(C}_{^{T}})εC(Λ,u_{₀}_{,)}φ(C^{T})Pr(x=φ(C^{T})) (27)
2) Coordinate level feedback: If Kᵢ is the ith coordinate alphabet, the average interference value at position i is
x_{IC,i}=Σ_{ζε}_{ᵢ}ζPr(xᵢ=ζ). (28)
Let x_{IC}, i̅ denote the vector obtained by setting the i-th element of x_{IC} to zero, i.e., x_{IC, i̅}=[ . . . , x_{IC,i-1}, 0, x_{IC,i+1}, . . . ]^{T}, the interference cancellation is performed for the i-th branch
ŷᵢ=y−Hx_{IC, i̅,} (29)
and the soft estimate \hat{x}ᵢ of the i-th branch after IC is
\hat{x}ᵢ=mᵢ^{T}ŷᵢ
subject to a unit power constraint like (24). The estimation (30) is referred to IC-MMSE. The covariance matrix of ŷᵢ, denoted as R_{IC,i}, is

$${R}_{1 C , i} = {HQ}_{IC , i} {H}^{H} + \frac{{N}_{0}}{2} I \qquad ( 31 )$$

with

$${Q}_{1 C , i} = \frac{P}{2 {N}_{t}} I - diag \{ {x}_{IC , \overline{i}} \} diag \{ {x}_{IC , \overline{i}} \} .$$

Substituting R_{IC,i} of (31) for R in (25), (26), yields the IC-MMSE solution mᵢ and the corresponding MSE σ²ᵢ, respectively. Note that the IC-MMSE filter bank is a more general solution than a MMSE filter bank for removing channel effects in a MIMO scenario. After IC-MMSE filtering the soft estimate of the ith branch is
\hat{x}ᵢ=xᵢ+nᵢ (32)
with
\hat{n}ᵢ˜ [symbol] (0,σᵢ²),
or written in a matrix form as
\hat{x}=x+\hat{n}. (33)
B. Belief Propagation Detector for Lattice Code Based on Tanner Graph Representation

After IC-MMSE equalization, the soft estimate \hat{x} of a lattice point is obtained. Recall that in lattice space-time schemes, the codebook of transmitted vectors x is a lattice code C(Λ, u₀, R), where the generator matrix of Λ is ΓB. For simplicity, let B be a generic lattice generator matrix. Lattice detection is to either decide which lattice point inside the shaping region has the minimum distance to \hat{x}, or calculate the soft information (e.g., in the form of probability or log-likelihood ratio) about each candidate lattice point. The first detection criterion leads to hard decision detectors—e.g., maximum likelihood (ML). The second decoding criterion leads to soft decision detectors, which can be used in iterations between detection and decoding. In this section, a novel Tanner graph based lattice decoding algorithm is introduced. For simplicity, assume an m-dimensional lattice code, i.e., \hat{x}ε [symbol] .

The novel lattice decoding algorithm introduced below relies on Tanner graph representations of lattices [29], which are enabled by lattice partitioning; all lattice points (those inside the shaping region are of interest) are partitioned into several subgroups (cosets). Each subgroup includes several different lattice points, and is labeled by a well-defined Abelian group block codeword. Then, a reduced-complexity soft-output lattice detector can be obtained by operating on the smaller number of cosets instead of lattice points. The labels of all cosets form an Abelian block code, which can be represented by a Tanner graph similar to low-density-parity-check (LDPC) codes. Belief propagation on a lattice is performed on its non-binary label Tanner graph to yield the total and extrinsic APP of the labels and their coordinates, as described in the following subsections. The APPs of individual lattice points are obtained in a final step described in Section III-D.

A somewhat subtler point is that lattice partitioning revolves around an orthogonal sublattice Λ′ of Λ, and the quotient group Λ/Λ′; |Λ/Λ′| is finite if Λ and Λ′ have the same dimensionality. The most straightforward way of obtaining Λ′ is by G-S orthogonalization of Λ's generator matrix, whereby all orthogonal G-S directions intercept Λ and the intersection naturally forms a sublattice of the same dimensionality as Λ; in all other cases the orthogonal sublattice will have to be obtained by some means other than G-S orthogonalization.
1) Gram-Schmidt (G-S) orthogonalization: Given a generator matrix B=[b₁ . . . bₘ], obtain a set of orthogonal vectors {wi}^{m}ᵢ₌₁.⁴ Let Wᵢ denote the vector space spanned by

$${w}_{i} , i . e . , {W}_{i} = α {w}_{i} , ∀ α ∈ R ; S {=}^{def} {\{ {W}_{i} \}}_{i = 1}^{m}$$

is a coordinate system.
2) Lattice label groups Gᵢ: Let P_{Wi}(Λ) be the projection of Λ onto the vector space Wᵢ, and

$${Λ}_{Wi} {=}^{def} Λ ⋂ {W}_{i} .$$

The quotient group P_{Wi}(Λ)/Λ_{Wi} is called a label group Gᵢ; Λ is now partitioned into a finite set of cosets labeled by n-tuples from

$$G {=}^{def} {G}_{1} \times … \times {G}_{m} .$$

The (finite) set of all label n-tuples, denoted L(Λ), is called the label code, and uses

$$G {=}^{def} {G}_{1} \times ⋯ \times {G}_{m} .$$

as its alphabet space.
3) Lattice label code L(Λ): Due to the isomorphism

$${G}_{i} ≅ {ℤ}_{{q}_{i}} , with {g}_{i} {=}^{def} \vert {G}_{i} \vert , let G = {ℤ}_{g 1} \times ⋯ \times {ℤ}_{gm} .$$

A lattice point will be labeled by the label of the coset to which it belongs. The label code L(Λ) is an Abelian block code. Let l=[l₁ . . . lₘ]^{T} denote a label, and Λ(l) denote the set of lattice points sharing the label l; clearly, labeling is invariant to translations of Λ by u₀. Let L(Λ), L(C(Λ,u₀, R)) denote the label codes of Λ, and of the subset of translated lattice points inside a shaping region R, respectively. Then, a translated lattice point inside R will have a label lεL(C(Λ, u₀, R)).
4) Finding a set of generator vectors

$${ν}^{+} {=}^{def} {\{ {υ}_{i}^{+} \}}_{i = 1}^{n}$$

for the dual label code L(Λ)* of Λ's label code L(Λ) [29]: The generator vectors
{vᵢ⁺}ᵢ₌₁ⁿ characterize the lattice Λ like a parity check equation characterizes a linear block code, and have the following property: all the labels in L(Λ) are orthogonal to every vector {vᵢ⁺}ᵢ₌₁ⁿ, i.e.,
   vᵢ^{+T}L(Λ)=0 mod lcm(g₁,g₂, . . . ,gₘ) (34)
   where lcm(•, . . . , •) is the least common multiple.
5) Lattice Tanner graph: The generator vectors {vᵢ⁺}ᵢ₌₁ⁿ act as check equations for the label code L(Λ), according to (34). Each coordinate of a label l corresponds to a variable node, and each generator vector that defines a check equation involving several label coordinates corresponds to a check node. A Tanner graph is constructed according to the constraints placed on label coordinates by the generator vectors {vᵢ⁺}ᵢ₌₁ⁿ. In general, the check equations are not over GF(2), unless the cardinalities of the label groups Gi are all two. Thereby, the TG of a lattice is, generally, non-binary.

### EXAMPLE 3

(Λ=D₄) A checkerboard lattice in [symbol] , denoted D₄, has a matrix generator:

$$B = [ \begin{matrix}1 & 1 & 1 & 2 \\ 1 & 0 & 1 & 0 \\ 0 & 1 & 1 & 0 \\ 0 & 0 & 1 & 0\end{matrix} ] . \qquad ( 35 )$$

The associated Gram-Schmidt vectors are

$${w}_{1} = {[ 1 , 1 , 0 , 0 ]}^{T} \\ {w}_{2} = {[ 1 / 2 , - 1 / 2 , 1 , 0 ]}^{T} \\ {w}_{3} = {[ - 1 / 3 , 1 / 3 , 1 / 3 , 1 ]}^{T} \\ {w}_{4} = {[ 1 / 2 , - 1 / 2 , - 1 / 2 , 1 / 2 ]}^{T} . \qquad ( 36 )$$

In the coordinate system, {Wᵢ}ᵢ₌₁⁴=span{wᵢ}ᵢ₌₁⁴
we obtain the following projection and cross-section:

$$\begin{matrix}{P}_{{W}_{1}} ( Λ ) = \frac{ℤ}{\sqrt{2}} \frac{{w}_{1}}{‖ {w}_{1} ‖} & {Λ}_{{W}_{1}} = \sqrt{2} ℤ \frac{{w}_{1}}{‖ {w}_{1} ‖} \\ {P}_{{W}_{2}} ( Λ ) = \frac{ℤ}{\sqrt{6}} \frac{{w}_{2}}{‖ {w}_{2} ‖} & {Λ}_{{W}_{2}} = \sqrt{6} ℤ \frac{{w}_{2}}{‖ {w}_{2} ‖} \\ {P}_{{W}_{3}} ( Λ ) = \frac{ℤ}{\sqrt{3}} \frac{{w}_{3}}{‖ {w}_{3} ‖} & {Λ}_{{W}_{3}} = 2 \sqrt{3} ℤ \frac{{w}_{3}}{‖ {w}_{3} ‖} \\ {P}_{{W}_{4}} ( Λ ) = ℤ \frac{{w}_{4}}{‖ {w}_{4} ‖} & {Λ}_{{W}_{4}} = 2 ℤ \frac{{w}_{4}}{‖ {w}_{4} ‖} .\end{matrix}$$

This results in the following quotient groups for D₄:

$${G}_{1} ( Λ ) = \{ 0 , \frac{\sqrt{2}}{2} \} , \\ {G}_{2} ( Λ ) = \{ 0 , \frac{\sqrt{6}}{6} , \frac{\sqrt{6}}{3} , \frac{\sqrt{6}}{2} , \frac{2 \sqrt{6}}{3} , \frac{5 \sqrt{6}}{6} \} , \\ {G}_{3} ( Λ ) = \{ 0 , \frac{\sqrt{3}}{3} , \frac{2 \sqrt{3}}{3} , \sqrt{3} , \frac{4 \sqrt{3}}{3} , \frac{5 \sqrt{3}}{3} \} , \\ {G}_{4} ( Λ ) = \{ 0 , 1 \}$$

The label code and the dual label code
L(Λ),L(Λ)*⊂ [symbol] × [symbol] × [symbol] × [symbol]
are, respectively [29],

$$L ( Λ ) = \{ 0000 , 0031 , 0220 , 0251 , 1300 , 1331 , 1520 , 1551 , 1140 , 1111 \; 0440 , 0411 \} , \\ {L ( Λ )}^{*} = \{ 0000 , 0240 , 0420 , 1511 , 1300 , 1331 , 0451 , 1540 , 1151 , 0031 \; 1120 , 0211 \} .$$

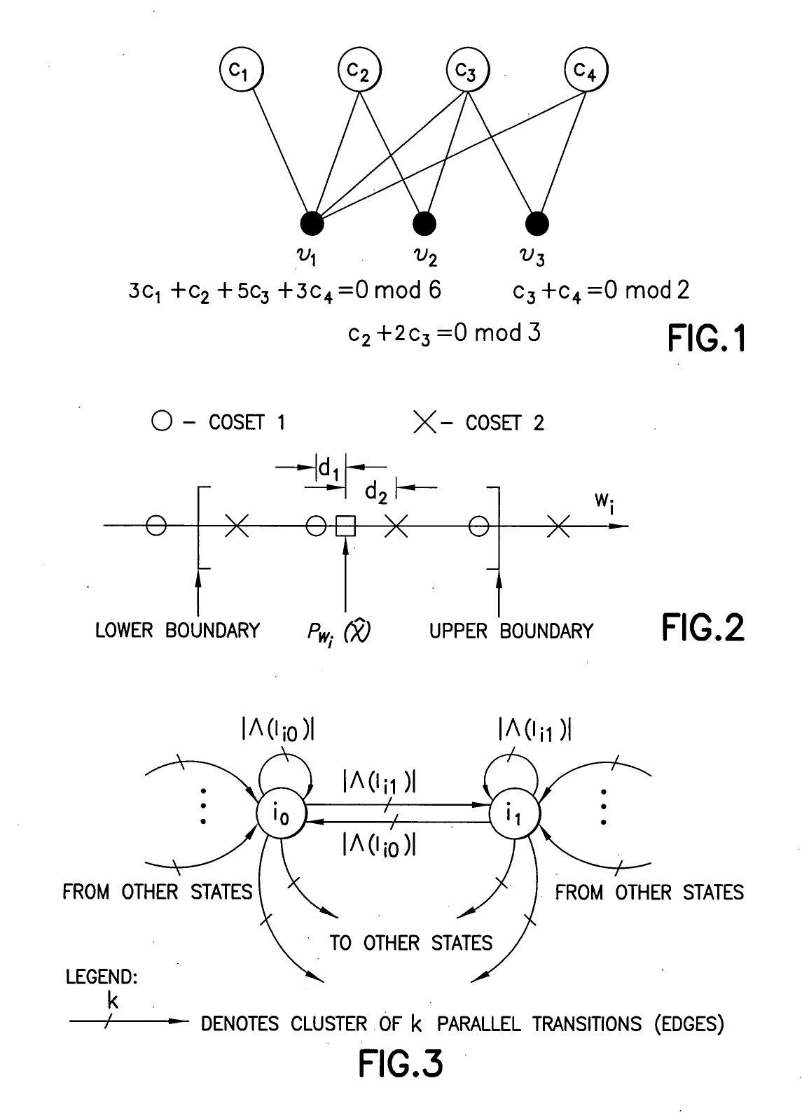

The generator set for L(Λ)* is v*={1151, 0240, 0031}. Since lcm(g₁, g₂, g₃, g₄)=6, the TG of label code L(Λ) can be constructed accordingly, as given in FIG. 1, where vⱼ is the j-th check node, and lᵢ is the i-th variable. The variable nodes associated with generator vector v*ⱼ are connected to vⱼ; e.g., check node v₁ is connected to all four variable nodes, because all variable nodes are involved in the first check equation.
6) Non-binary belief propagation [30]: P_{Wi}(\hat{x}) denotes the projection of \hat{x}, which may not be in Λ, onto vector space Wᵢ, i.e., P_{Wi}(\hat{x})=\hat{x}^{T}w₁/∥w₁∥. In the lattice Tanner graph a value αε{0, 1, . . . ,gᵢ−1} of the variable node lᵢ is associated with the hypothesis that \hat{x} is an observation of a lattice point whose label has i-th coordinate equal to α (or, whose projection on the vector space Wᵢ belongs to coset with label α), Pr(lᵢ=α) is the probability of this hypothesis. Essentially,

$${w}_{1} = {b}_{1} , {w}_{i} = {b}_{1} - {\sum }_{i = 1}^{i - 1} {μ}_{ij} {w}_{j} , i = 2 , ⋯ , m ,$$

where μᵢⱼ=<bᵢ,wⱼ>/<wⱼ,wⱼ>, and <•,•> denotes inner product.

Define messages qⱼᵢ^{α} and rⱼᵢ^{α} where the subscripts i, j refer to i-th variable node lᵢ and j-th qⱼᵢ^{α} check node vⱼ, respectively. The quantity is the probability of the hypothesis that \hat{x} is an observation of a lattice point vⱼ; rⱼᵢ^{α} whose label has i-th coordinate equal to α, given the information obtained via check nodes other than is the probability of check vⱼ being satisfied given that \hat{x} is an observation of a lattice point whose label has i-th coordinate equal to α. The message passing is [30]:

$$\begin{matrix}{r}_{ji}^{α} = {\sum }_{{l ∈ L ( Λ ) ,}_{{{υ}_{j}^{*} 1 ≡ 0}_{{l}_{i} = α}}} {\prod }_{k ∈ N ( j ) \backslash i} {q}_{jk}^{{l}_{k}} , & ( 37 ) \\ {q}_{ji}^{α} = {K}_{ji} {f}_{i}^{α} {\prod }_{k ∈ M ( i ) \backslash j} {r}_{ki}^{α} , & ( 38 )\end{matrix}$$

where Kⱼᵢ are so that Σ_{α}qⱼᵢ^{α}=1, [symbol] (j) is the set of variable nodes involved in check equation vⱼ, and M(i) is the set of checks nodes connected to variable node lᵢ; fᵢ^{α} is the initial probability of event lᵢ=α given observation \hat{x}.
C. Initializing the Lattice Tanner Graph

Belief propagation requires initializing fᵢ^{α} for the TG; this can be done in either projection domain or probability domain. After partitioning the infinite lattice into finitely many labeled cosets, not all labels are used by the points inside the finite shaping region; due consideration must be given to this aspect.

1) In projection domain: The soft estimate \hat{x} obtained from the LMMSE filters bank is projected onto vector spaces {Wi}^{m}i=1 (see FIG. 2); in general, fᵢ^{α} is initialized as:
(1). ∀lεLC(Λ, u₀, R)), find closest λεR∩{Λ(l)+u₀}:

$${λ}_{min} ( l ) = arg {min}_{λ ∈ Λ ( l )} {\sum }_{i = 1}^{m} {\vert {P}_{{W}_{i}} ( \hat{x} ) - {P}_{{W}_{i}} ( λ ) \vert}^{2} \qquad ( 39 )$$

(2). Calculate the probability of (subgroup with) label l:

$$Pr ( l ) = \frac{exp ( - {\sum }_{i = 1}^{m} \frac{{d}_{i}^{a} ( {λ}_{min} ( l ) )}{2 {σ}_{i}^{2}} )}{{\sum }_{l ∈ L ( C ( Λ , {u}_{0} , ℛ ) )} exp ( - {\sum }_{i = 1}^{m} \frac{{d}_{i}^{2} ( {λ}_{min} ( l ) )}{2 {σ}_{i}^{2}} ) ,} \qquad ( 40 )$$

with dᵢ(λₘᵢₙ(l))=P_{W}_{ᵢ}(\hat{x})−P_{W}_{ᵢ}(λₘᵢₙ(l))| and σ²ᵢ of (26).
(3). Initialize f^{α}ᵢ from Pr(l):
fᵢ^{α}=Σₗ_{ᵢ}ₗ_{ᵢ}_{=α}Pr(l). (41)

Then q^{α}ⱼᵢ is initialized to f^{α}ᵢ. The belief propagation algorithm is implemented by updating r^{α}ⱼᵢ and q^{α}ⱼᵢ iteratively until a predetermined number of iterations is achieved.
Remark 1. (Simplified initialization) One can examine \hat{x} along each Wᵢ separately—no precaution taken to verify that selecting the closest projection coordinate in each direction, in isolation from other directions, yields collectively a point inside the shaping region.
(1) ∀l, the minimum distance dᵢ(l) along Wᵢ is
dᵢ(l)=arg min_{λεΛ(l)}|P_{W}_{ᵢ}(\hat{x})−P_{W}_{ᵢ}(λ)|. (42)
(2). Calculate the probability of subgroup with label l via

$$Pr ( l ) = \frac{exp ( - {\sum }_{i = 1}^{m} \frac{{d}_{i}^{2} ( l )}{2 {σ}_{i}^{2}} )}{{\sum }_{l ∈ L ( C ( Λ , {μ}_{0} , ℛ ) )} {\sum }_{i = 1}^{m} exp ( - \frac{{d}_{i}^{2} ( l )}{2 {σ}_{i}^{2}} )} .$$

Lastly, f^{α}ᵢ is initialized according to (41). This approach is referred to as simplified initialization, which is less complicated than the previous one—hence a slight performance loss.

2) In probability domain. Given the soft estimates in \hat{x}, the likelihoods of each coordinate⁵ of xεΛ at the k-th MIMO channel use are calculated from the soft estimates in \hat{x}⁶:
P(\hat{x}ᵢ|xᵢ=c^{j})=K exp(−∥\hat{x}ᵢ−c^{j}∥²/2σᵢ²), (43)
where c^{j} is the j-th real coordinate xᵢ of xεΛ∩R. Then, the likelihood of each value of coordinate xᵢ at the k-th MIMO channel use will form the component Pₖ(c^{j}; I) of a vector input Pₖ(c;I) to a SISO APP module, following the model and notations in [32]; as in [32], C^{j}ₖ will denote a random process enacted by a sequence of (coordinate) symbols taking values from some alphabet
{c^{j}|jεJ}—which nonetheless may be nonbinary, i.e. j is from a set of cardinality |J|>2.
⁵ A real coordinate of a lattice point, not an integer coordinate of a label.

⁶ The subscript k, which would indicate the time index of the relevant MIMO channel use, is omitted here and in FIG. 4 for simplicity of notation.

D. Computation of Extrinsic APP—Either (Lattice) Point-Wise or Coordinate-Wise—after Belief Propagation

In order to implement iterative receivers it is necessary to compute the a posteriori probability at the end of belief propagation. After the last iteration, the belief propagation returns r^{α}ⱼᵢ and q^{α}ⱼᵢ, ∀α, i, j. Then, the total a posteriori probability Pr (lᵢ=α) is computed as

$$Pr ( {l}_{i} = α ) = {f}_{i}^{α} {\prod }_{j ∈ M ( i )} {r}_{ji}^{α} , \qquad ( 44 )$$

and the total a posteriori probability of each label is given by

$$Pr ( l = \{ {α}_{1} , {α}_{2} , ⋯ , {α}_{m} \} ) = {\prod }_{i = 1}^{m} Pr ( {l}_{i} = {α}_{i} ) . \qquad ( 45 )$$

In Appendix I it is shown that when a lattice is represented by a Tanner graph, it is possible to associate a Markov process with the model for soft detection of lattice points, as shown in FIG. 3; also, that the extrinsic APPs Pₖ^{BP} (c^{j}; O) and Pₖ^{BP} (u^{j}; O) after belief propagation, corresponding to the k-th transition between states, can be computed as:

$$\begin{matrix}{P}_{k}^{BP} ( {c}^{j} ; O ) = {\sum }_{e \text{:} {C}_{k}^{j} ( e ) = {c}^{j}} Pr ( {l}_{s} {s}_{( e )} ) {\prod }_{i = 1}^{m} {P}_{k} [ {u}^{i} ( e ) ; I ] \times {\prod }_{i = 1 , i \neq j}^{m} {P}_{k} [ {c}^{i} ( e ) ; I ] , & ( 46 ) \\ {P}_{k}^{BP} ( {u}^{j} ; O ) = {\sum }_{e \text{:} {U}_{k}^{j} ( e ) = {u}^{j}} Pr ( {l}_{s} {s}_{( e )} ) {\prod }_{i = 1 , i \neq j}^{m} {P}_{k} [ {u}^{i} ( e ) ; I ] \times {\prod }_{i = 1}^{m} {P}_{k} [ {c}^{i} ( e ) ; I ] , & ( 47 )\end{matrix}$$

where lₛs(e) is the label indexed by the integer value of the starting state s^{s}(e) of edge e. Pₖ[uⁱ(e); I] and Pₖ(cⁱ(e), I) are the a priori probabilities of an unencoded, respectively encoded, symbol element (in this case a coordinate⁷) at position i, which are associated with edge e [32]. In a serial concatenation such as in FIG. 4, the unencoded symbol elements are assumed to be identically distributed according to a uniform distribution, and Pₖ[uⁱ(e); I] is the reciprocal of the alphabet size at position i. Pₖ(cⁱ(e); I) are the likelihoods of lattice point coordinates, which can be computed as in the Tanner graph initialization step.
⁷ i.e., not necessarily a binary symbol, or bit.

$$∀ edge e , u ( e ) = λ ∈ Λ ( {l}_{i} ) -> \{ \begin{matrix}{s}^{E} ( e ) = i , i ∈ \{ 1 , ⋯ , \vert L ( Λ ) \vert \} \\ c ( e ) = u ( e )\end{matrix}$$

### IV. APPLICATION TO THE DETECTION OF SUPER-ORTHOGONAL LATTICE SPACE-TIME CODE

Consider the superorthogonal space-time code [18], [19], [20], [21], [22], [23] as the MIMO transmission scheme. The decoding algorithm developed in the previous section combined with hypothesis testing is introduced as an efficient MIMO detector.

A. Receiver for Quasistatic Scenarios

Consider the superorthogonal space-time code given in Example 2. The ML receiver for x_{⊕} is given by

$${x}_{⊕ ; ML} = arg {min}_{∀ {x}_{⊕}} {‖ y - {H}_{⊕} {x}_{⊕} ‖}^{2} . \qquad ( 48 )$$

The ML receiver is usually computationally complicated since it needs to examine all valid lattice points (complexity grows exponentially). The algorithm introduced in Section III offers a computationally efficient solution.

Recall that for a superorthogonal space-time code (see Example 2), either all χ₁ or all χ₁′ are zeros, which identifies two hypotheses: hypothesis H₁ is that χ₁′ are all zeros, and the base matrices C are chosen; hypothesis H₂ is that χ₁ are all zeros, and the base matrices C′ are chosen. When hypothesis H₁ is true, the transmission model (19) can be simplified as
y=H_{⊕}¹χ+n. (49)

When hypothesis H₂ is true, we have
y=H_{⊕}²χ′+n. (50)

Due to the orthogonality of matrices H^{k}_{⊕}, k=1, 2, the MMSE filters for χ, χ′ are the corresponding matched filters

$${M}^{k} = \frac{1}{α} {( {H}_{⊕}^{k} )}^{H} , k = 1 , 2 \qquad ( 51 )$$

where M^{k} are MMSE filters for hypothesis Hₖ. The output of MMSE filters for hypothesis H₁ and H₂ are then given by

$$\begin{matrix}\hat{χ} = {M}^{1} y = \frac{1}{α} {( {H}_{⊕}^{1} )}^{H} y = χ + {\tilde{n}}^{1} & ( 52 ) \\ {\hat{χ}}^{′} = {M}^{2} y = \frac{1}{α} {( {H}_{⊕}^{2} )}^{H} y = {χ}^{′} + {\tilde{n}}^{2} & ( 53 )\end{matrix}$$

where ñ¹ and ñ² are estimation noise after filtering for hypothesis H₁ and H₂, respectively. It is not difficult to see that ñ^{k}, k=1, 2 are white multivariate Gaussian random vectors, i.e.,

$$, {\tilde{n}}^{k} ∼ 𝒩 ( 0 , \frac{{N}_{0}}{2 α} I )$$

It should be pointed out that the IC is not necessary for this scenario and the estimations of (52), (53) are interference-free estimates of χ and χ′, respectively, due to the orthogonality of H^{k}_{⊕}.

The probability of hypothesis H₁ given y is:
Pr(H₁|y)=Σ_{χ}Pr(H₁,χ|y). (54)

In (54), summing over all valid values among χ becomes infeasible as the length of χ increases. In order to reduce the complexity, use the term that has the maximum value to approximate the summation (54). That is,

$$\begin{matrix}Pr ( {H}_{1} \vert y ) \approx max χPr ( {H}_{1} , χ \vert y ) ∼ p ( y \vert {H}_{⊕}^{1} , {χ}_{max} ) \\ with & ( 55 ) \\ \begin{matrix}{χ}_{max} = arg max χp ( y \vert {H}_{⊕}^{1} , χ ) = arg min χ {\vert y - {H}_{⊕}^{1} χ \vert}^{2} \\ = arg min χ {\vert \hat{χ} - χ \vert}^{2} = sign ( \hat{χ} )\end{matrix} & ( 56 )\end{matrix}$$

where \hat{χ} is the output of the LMMSE filtering for hypothesis H₁ and is given in (52). Similarly,

$$\begin{matrix}Pr ( {H}_{2} \vert y ) \approx {max}_{{χ}^{′}} Pr ( {H}_{2} , {χ}^{′} \vert y ) ∼ p ( y \vert {H}_{⊕}^{2} , {χ}_{max}^{′} ) & ( 57 ) \\ {χ}_{max}^{′} {=}^{def} arg {min}_{{χ}^{′}} \vert y - {H}_{⊕}^{2} {χ}^{′} {\vert}^{2} = sign ( {\hat{χ}}^{′} ) . & ( 58 )\end{matrix}$$

The log likelihood ratio of hypothesis H₁ and H₂ is

$$\begin{matrix}L ( H ) = log \frac{Pr ( {H}_{1} \vert y )}{Pr ( {H}_{2} \vert y )} \approx log \frac{p ( y \vert {H}_{⊕}^{1} , {χ}_{max} )}{p ( y \vert {H}_{⊕}^{2} , {χ}_{max}^{′} )} \\ = \frac{2 α}{{N}_{0}} ( {‖ y - {H}_{⊕}^{2} {χ}_{max}^{′} ‖}^{2} - {‖ y - {H}_{⊕}^{1} {χ}_{max} ‖}^{2} ) \\ = \frac{4 α}{{N}_{0}} ( {y}^{H} {H}_{⊕}^{2} {χ}_{max} - {y}^{H} {H}_{⊕}^{1} {χ}_{max}^{′} ) \\ = \frac{4 {α}^{2}}{{N}_{0}} ( {\hat{χ}}^{H} {χ}_{max} - {\hat{χ}}^{′ H} {χ}_{max}^{′} )\end{matrix} \qquad ( 59 )$$

Substituting (56) and (57) into (59) yields
   L(H)=(ABS(\hat{χ})−ABS(\hat{χ}′))4α²/N₀ (60)
   where ABS(a)=Σ|Σaᵢ|. Consequently, the probability of hypotheses H₁, H₂ can be obtained from L(H)
   Pr(Hₖ|y)=1/(1+exp(∓L(H))), k=1,2. (61)

For each hypothesis one can apply the lattice detection algorithm developed in Section III for detecting x. We treat the information-bearing vector χ as a lattice with generator matrix B, i.e., χ=Bu. For example, the equivalent model for detecting lattice point χ is \hat{χ}=Bu+ñ¹, where \hat{χ} is the output of matched filtering of hypothesis H₁. Since χ is from a D₄ lattice, its generator matrix B is given in (35). The APPs can be obtained according to Section III.

B. Iterative Receiver for Coordinate Interleaving in Fast Fading

Coordinate interleaving, along with the outer iteration loop in FIG. 4, is now considered; the real and imaginary parts of all complex symbols in a frame are collectively scrambled before transmission [34]. Y={y₁, y₂, . . . , y_{N}} denotes a frame spanning N MIMO channel uses at the MIMO channel output (before deinterleaving). Note that the structure of the superorthogonal lattice code is removed during transmission, and has to be recovered before detection. The applicable receive equation is (6) rather than (19); the iterative IC-MMSE attempts to iteratively remove the cross-antenna interference, i.e. to undo the channel H on a per MIMO channel use basis. During the first iteration, the soft feedback from the detector/decoder is null. The output of IC-MMSE is always deinterleaved, thus restoring the superorthogonal structure and yielding the soft output \hat{X}={\hat{x}₁*,\hat{x}₂, . . . ,\hat{x}_{N}} with
\hat{x}ₜ=Γχ_{⊕,t}+ñₜ. (62)

Since the information-bearing vector χ_{⊕;t} is a direct sum of two D₄ lattices, and the effective channel gain matrix Γ is unitary, the equalization approach in Section IV-A applies to eq. (62). Pr(Hₖ|\hat{x}t), k=1, 2, are associated with the following transmission models upon removing Γ₁, Γ₂ respectively:
H₁:\tilde{χ}ₜ=Buₜ+ñₜ¹ (63)
H₂:\tilde{χ}ₜ=Bu′ₜ+ñₜ² (64)
where

$${\overline{χ}}_{t} = \frac{1}{2} {Γ}_{1}^{T} {\hat{x}}_{t} , {\overline{χ}}_{t}^{′} = \frac{1}{2} {Γ}_{2}^{T} {\hat{x}}_{t} , {\overline{n}}_{t}^{1} = \frac{1}{2} {Γ}_{1}^{T} {\overline{n}}_{t} and {\overline{n}}_{t}^{2} = \frac{1}{2} {Γ}_{2}^{T} {\overline{n}}_{t} .$$

The generator matrix B is given in (35). For each hypothesis, the lattice decoding algorithm can be applied to compute the extrinsic APPs P(u; O) and P(c; O).

Inner-loop iterative decoding between SISO and BP, as shown in FIG. 4, can further improve the overall performance, especially in the presence of forward error correction coding, when decoding follows detection. Herein, only an uncoded system is considered in order to illustrate the concept. Even in an uncoded system it is possible to perform inner loop iterations between P^{BP}((c; O) from the belief propagation module and P(u, I) from the SISO block; more benefit is derived however when a decoder is part of the inner-loop.

### V. SIMULATIONS

Simulation results for a superorthogonal space-time lattice code with 4PSK constellation (Example 2), in both quasistatic and fast fading channels, are discussed. Each half of the superorthogonal constellation belongs to a D₄ lattice, implicitly defining a shaping region; only six of the twelve L(Λ) labels listed in Example 3 (first four, last two) are needed to cover the lattice points in the shaping region. In order to test the algorithm's efficiency, only the most likely label (or two labels)—post belief propagation—are retained; the others receive zero probabilities (re-normalization is performed after setting to zero the probabilities of discarded labels).

A. Quasistatic Fading

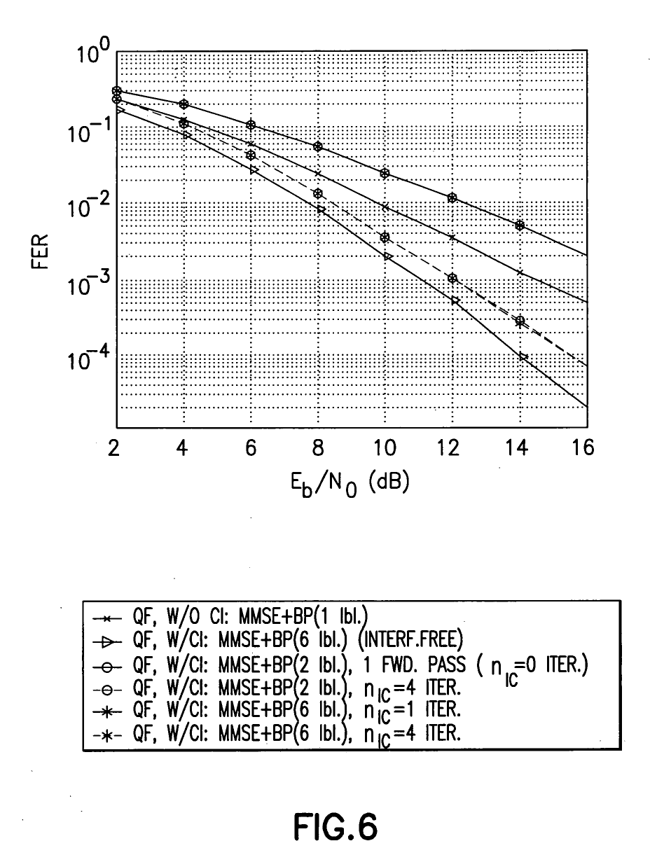

The channel is constant over T=2 symbol periods. In our simulations, each data packet includes 500 super-orthogonal codewords. Each point on the curves plotted in FIG. 5 and FIG. 6 is obtained by testing 2000 independent data packets.

FIG. 5 shows the FER (frame error ratio)⁸ vs. E_{b}/N₀ for super-orthogonal space-time code when the coordinate interleaver is absent. QPSK modulation is employed and the channel spectral efficiency is 2.5 bits/channel use. The performance of the ML algorithm that exhaustively searches all possible valid codewords and picks the one with the ML is plotted as reference. For the MMSE-BP algorithm, we run one iteration for the Tanner graph and collect the probability of the coordinate of label. Then we consider choosing one surviving label and two surviving labels. The simulation result shows that the MMSE-BP algorithm with one surviving label and two surviving labels have the same performance as that of the ML algorithm. The MMSE-BP with simplified initialization that reduces the overall complexity is also examined. In this case, we consider two surviving labels, the results show that it is about 0.5 dB away from the ML performance in low SNR region. As SNR increases, the MMSE-BP with simplified initialization approaches the ML performance asymptotically.
⁸ One frame is meant to be one super-orthogonal space-time codeword

B. Fast Fading

Fast fading simulations include a coordinate interleaver. In our simulations, a depth-eight traditional block interleaver is considered. QPSK is used and the channel spectral efficiency is 2.5 bits/channel use. Two inner iterations are run between the SISO block and the BP block; one iteration is run on the lattice Tanner graph inside the BP block. We simulate different scenarios where different number of surviving labels are considered. In addition, iterative interference cancellation scheme is considered to improve the overall performance. The soft estimator computes the soft estimates of the coordinates of lattice point based on the output from the BP (P(u; O)). FIG. 6 shows the FER vs. E_{b}/N₀ for different number of surviving labels and different number of iterations between the IC-MMSE and the outer decoder.

### VI. CONCLUSION

A soft output closest point search in lattices was introduced, via a form of belief propagation on a lattice. Due to the coding gain associated with a lattice, structural relations exist between certain lattice points, which can be associated via an equivalence relation for detection purposes. This leads to a soft output detection algorithm, which can generate both total and extrinsic a posteriori probability at the detector's output. The step-back feature of classic sphere decoding is eliminated.

### APPENDIX I

### Computing the Extrinsic A Posteriori Probabilities after Belief Propagation

Herein, the expressions for extrinsic a posteriori probabilities (46), (47), at the belief propagation detector's output, are derived; the extrinsic probabilities are needed in iterative receivers. Here, the goal of detection is to provide soft information about valid channel alphabet symbols, i.e. real coordinates of the complex symbols from the modulation constellations used on various transmit antennas; this information about coordinates can be used to revert the effect of a coordinate interleaver, or can be forwarded directly to a soft decoder for some coded modulation encoder. Alternatively, it can be used for soft or hard demodulation, e.g. in the case of bit interleaved coded modulation, or with plain uncoded transmission.

When a lattice is represented by a Tanner graph, it is possible to associate a Markov process with the model for soft detection of lattice points in a natural way. This is enabled by first viewing the sequence of lattice points passed through the channel as a Markov source. Another observation is that, in general, simple detection (with or without soft information) is by itself memoryless; thereby, one should expect the Markov process to be somehow degenerated, in order to reflect the memoryless nature of simple (non-iterative) detection. The objective of detection is to determine the aposteriori (total or extrinsic) probabilities of the output of the Markov source. In order to leverage off of known results—even in the case of plain, unencoded transmission (no forward error correcting redundancy added by encoding)—one can view the output c of the Markov source (a lattice point, i.e. a vector of lattice coordinates) as the result of mapping with rate one (i.e. no additional redundancy) an identical replica of the input u=c; this is a degenerated Markov process where even the dependence of the future on the present is removed. The only remaining structure to be captured for the Markov source, in the case when the candidate points are from a lattice, must reflect the partitioning in labeled cosets, as discussed in Section III-B. To this end, note that the labels themselves can be associated with states having integer values by virtue of the following convention: the state Sₖ−1 at time k−1 is the index of the label that contains the most recent lattice point output by the Markov source, i.e. at time k−1; when the Markov source outputs a new point at time k it transitions into state Sₖ equal to the integer indexing the label that contains the new point. Alternatively, with respect to the mapping u|→c and omitting the time index, when u=λεΛ occurs at the rate-one block input, the Markov process transitions into the state whose (integer) value indexes the label containing λ. This is represented in FIG. 3, where e denotes an edge between starting state s^{S}(e) and ending state s^{E}(e). Formally, for any edge e, at any time, if u(e)=λεΛ(lᵢ)⊂Λ, where iε{1, . . . |L(Λ)|} indexes one of the |L(Λ)| labels, then the ending state s^{E}(e)=i and the Markov source outputs c(e)=u(e). There is a bijective mapping i between integer states and labels

$$s {↦}^{ℓ} {l}_{s}$$

such that, for any integer state sε{1, . . . |L(Λ)|},

$$ℓ ( s ) {=}^{def} {l}_{s}$$

is the label associated with s.

The Markov sequence of random points selected from the lattice can be thus viewed as triggered by state transitions triggered by u=λεΛ; although the realizations of u on the lattice grid are random, a state model arises as a result of partitioning the lattice in equivalence classes. That is, there exist certain structural relations between certain points, which can be associated via an equivalence relation. The state probabilities, used in a posteriori probability calculations, are seen to be associated with the probabilities of these equivalence classes (or their labels), which can be obtained separately from belief propagation on the lattice's Tanner graph, as shown next.

In general, for a Markov process generated by triggering state transitions via some input (e.g. a classical convolutional code), the new state depends on the current input and several previous inputs; in the case at hand the new state depends only on the current input. This illustrates the degenerated nature of the Markov process at hand, seen thereby to be memoryless.

The memoryless nature of the Markov process is also apparent in the fact that any state can be reached in one transition from any state, and the probability distribution of the states does not depend on time; it depends only on the probability distribution for u, and so does the probability distribution of the output of the Markov process. The output of the Markov process does not depend on the current state, but rather on the input u; the input determines both the new output and the new state, which implies that the output any time does not depend on any previous state.

The remainder of this appendix will use the state transition diagram in FIG. 3 for the Markov process that forms the object of detection; the results in [32], [33] apply. Following [32], the extrinsic APPs Pₖ^{BP}(c^{j}, O) and Pₖ^{BP}(u^{j}; O) during the k-th transition between states have the general expressions

$$\begin{matrix}{P}_{k}^{PB} ( {c}^{j} ; O ) = {\sum }_{e : {C}_{k}^{j} ( e ) = {c}^{j}} {A}_{k - 1} [ {s}^{s} ( e ) ] {\prod }_{i = 1}^{m} {P}_{k} [ {u}^{i} ( e ) ; I ] \times {{\prod }^{m}}_{i = 1 ; i \neq j} {P}_{k} [ {c}^{i} ( e ) ; I ] {B}_{k} [ {s}^{E} ( e ) ] , & ( 65 ) \\ {P}_{k}^{PB} ( {u}^{j} ; O ) = {\sum }_{e : {U}_{k}^{j} ( e ) = {u}^{j}} {A}_{k - 1} [ {s}^{s} ( e ) ] {\prod }_{i = 1 ; i \neq j}^{m} {P}_{k} [ {u}^{i} ( e ) ; I ] \times {{\prod }^{m}}_{i = 1} {P}_{k} [ {c}^{i} ( e ) ; I ] {B}_{k} [ {s}^{E} ( e ) ] , & ( 66 )\end{matrix}$$

where Aₖ₋₁[s^{S}(e)] and Bₖ[s^{E}(e)] are the probabilities of the current state and the new state that are associated with edge e.

Following the well-known results and notation in [33] and using the memoryless nature of the Markov process in FIG. 3,

$$\begin{matrix}{A}_{k} [ s ] {=}^{def} Pr \{ {S}_{k} = s ; {y}_{1}^{k} \} = Pr \{ {S}_{k} = s ; {y}_{k} ; {y}_{1}^{k - 1} \} & \\ = Pr \{ {S}_{k} = s ; {y}_{k} \vert {y}_{1}^{k - 1} \} Pr \{ {y}_{1}^{k - 1} \} & ( 67 ) \\ = Pr \{ {S}_{k} = s ; {y}_{k} \} Pr \{ {y}_{1}^{k - 1} \} = Pr \{ {S}_{k} = s ; {y}_{k} \} {κ}_{0 ,} & ( 68 )\end{matrix}$$

where, following [33], y^{τ}₀ denotes the observations of the relevant Markov process, as taken at the output of a discrete memoriless channel at time instants 0, 1, . . . , τ. Most importantly, the factor κ₀ does not depend on the state s, and is thereby cancelled out during the normalization step that enforces ΣₛAₖ┌s┐=1. Due to the isomorphism between states and labels it follows that Pr{Sₖ=s; yₖ} is the label probability Pr (l(s))=Pr(lₛ) calculated as in (45). From [33] and the properties of the degenerated Markov process,

$${B}_{k} [ s ] {=}^{def} Pr \{ {y}_{k + 1}^{τ} \vert {S}_{k} = s \} = Pr \{ {y}_{k + 1}^{τ} \} , \qquad ( 69 )$$

which does not depend on the state s and behaves as a constant that is cancelled out during the normalization step enforcing ΣₛBₖ[s]=1. Therefore (46), (47) follow.

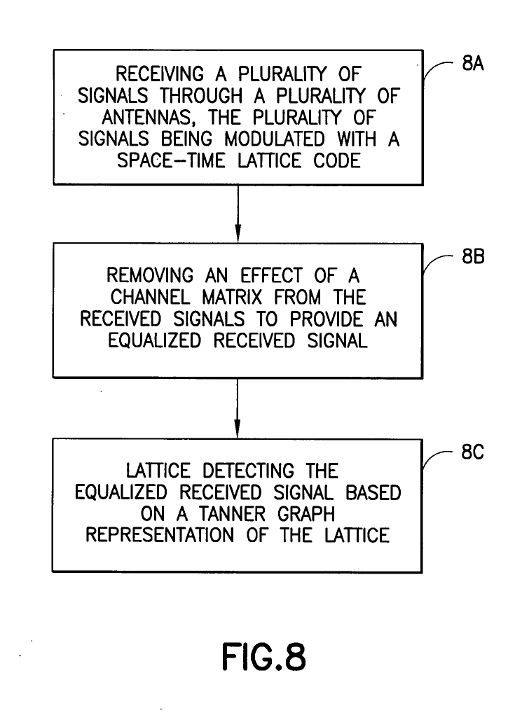

Referring to FIG. 8, an aspect of the exemplary embodiments of this invention resides in a method, such as one that may be used in a MIMO receiver. The method includes: (Block 8A) receiving a plurality of signals through a plurality of antennas, the plurality of signals being modulated with a space-time lattice code; (Block 8B) removing an effect of a channel matrix from the received signals to provide an equalized received signal; and (Block 8C) lattice detecting the equalized received signal based on a Tanner graph representation of the lattice.

The use of the exemplary embodiments of this invention enables and provides at least the advantages of soft output detection, no step back artifact generation, modularization of receiver implementation, wherein all practical constellations may be viewed as lattices (in a sense that they may be, e.g., degenerated lattices or cubic lattices). The use of the exemplary embodiments of this invention enables and provides a practical and efficient technique and means for decoding large constellations from multiple transmit antennas.

The exemplary embodiments of this invention can be applied to and used in, as non-limiting examples, E-UTRAN systems, OFDM-based systems, WCDMA systems, multi-carrier systems, so-called 3.9G (3.9 generation) systems and so-called 4G (fourth generation) systems, as well as in multi-band and multi-mode user equipment and terminals.

In general, the various embodiments may be implemented in hardware or special purpose circuits, software, logic or any combination thereof. For example, some aspects may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

Embodiments of the inventions may be practiced in various components such as integrated circuit chips and modules. The design of integrated circuits is by and large a highly automated process. Complex and powerful software tools are available for converting a logic level design into a semiconductor circuit design ready to be etched and formed on a semiconductor substrate. Commercially available programs and systems may automatically route conductors and locate components on a semiconductor chip using well established rules of design, as well as libraries of pre-stored design modules. Once the design for a semiconductor circuit has been completed, the resultant design, in a standardized electronic format (e.g., Opus, GDSII, or the like) may be transmitted to a semiconductor fabrication facility or “fab” for fabrication.

Various modifications and adaptations may become apparent to those skilled in the relevant arts in view of the foregoing description, when read in conjunction with the accompanying drawings. However, any and all modifications of the teachings of this invention will still fall within the scope of the non-limiting embodiments of this invention.

Furthermore, some of the features of the various non-limiting embodiments of this invention may be used to advantage without the corresponding use of other features. As such, the foregoing description should be considered as merely illustrative of the principles, teachings and exemplary embodiments of this invention, and not in limitation thereof.

### REFERENCES

[1] M. Pohst, “On the computation of lattice vectors of minimal length, successive minima, and reduced basis with applications,” ACM SIGSAM Bull., vol. 15, pp. 37-44, 1981
[2] U. Fincke and M. Pohst, “Improved methods for calculating vectors of short length in a lattice, including a complexity analysis,” Math. Comput., vol. 44, pp. 463-471, April 1985
[3] C. P. Schnorr and M. Euchnerr, “Lattice basis reduction: improved practical algorithms and solving subset sum problems,” Math. Programming, vol. 66, pp. 181-191,April 1994
[4] E. Viterbo and J. Boutros, “A universal lattice decoder for fading channels,” IEEE Trans. Inform. Theory, vol. 45, No. 5, pp. 1639-1642, July 1999.
[5] J. Boutros, N. Gresset, L. Brunel, and M. Fossorier, “Soft-input soft-output lattice sphere decoder for linear channels,” Proc. IEEE Conf. Globecom '03, pp. 1583-1587, 2003.
[6] S. Bäro, J. Hagenauer, and M. Witzke, “Iterative detection of MIMO transmission using a list-sequential (LISS) detector,” IEEE International Conf. Commun., ICC '03, vol. 4, pp. 2653-2657, Anchorage, May 2003
[7] Y. de Jong and T. Willink, “Iterative tree search detection for MIMO wireless systems,” IEEE 56th Vehicular Technology Conf. VTC '02 Proceedings, vol. 2, pp. 1041-1045, September 2002
[8] M. O. Damen, H. El-Gamal, and G. Caire, “On Maximum-Likelihood Detection and the Search for the Closest Lattice Point,” IEEE Trans. Inform. Theory, vol. 49, No. 10, pp. 2389-2402, October 2003.
[9] A. H. Banihashemi and I. F. Blake, “On the Trellis Complexity of Root Lattices and Their Duals,” IEEE Trans. Inform. Theory, vol. 45, No. 6, pp. 2168-2172, September 1999.
[10] S. Liu and Z. Tian, “Near-Optimum Soft Decision Equalization for Frequency Selective MIMO Channels,” IEEE Trans. Signal Proc., vol. 52, No. 3, pp. 721-733, March 2004.
[11] B. Steingrimsson, Z.-Q. Luo, and K. M. Wong, “Soft quasi-maximum-likelihood detection for multiple-antenna wireless channels,” IEEE Trans. Signal Proc., vol. 51, No. 11, pp. 2710-2719, November 2003.
[12] B. Dong, X. Wang, and A. Doucet, “A New Class of Soft MIMO Demodulation Algorithms,” IEEE Trans. Signal Proc., vol. 51, No. 11, pp. 2752-2763, November 2003.
[13] D. Seethaler, H. Artés, and F. Hlawatsch, “Efficient approximate-ML detection for MIMO spatial multiplexing systems by using a 1-D nearest neighbor search,” pp. 290-293.
[14] D. Le Ruyet, T. Bertozzi, and B. Özbek, “Breadth first algorithms for APP detectors over MIMO channels,”, pp. 926-930, 2004.
[15] M. E. Ramirez Montalvo, “Sub-optimal non-linear detection methods for high data rate systems using multiple antennas,” Master's Thesis, Electrical and Communications Engineering Department, Helsinki Univ. Technology, Nov. 20, 2003.
[16] A. K. Lenstra, H. W. Lenstra, and L. Lovász, “Factoring polynomials with rational coefficients,” Math. Ann., vol. 261, pp. 515-534, April 1982
[17] A. H. Banihashemi and I. F. Blake, “Trellis structure and decoding complexity of lattices,” Ph. D. dissertation, ECE Dept., Univ. Waterloo, Waterloo, ON, Canada, 1997
[18] D. M. Ionescu, K. K. Mukkavilli, Z. Yan, and J. Lilleberg, “Improved 8- and 16-State Space-Time codes for 4PSK with Two Transmit Antennas,” IEEE Commun. Letters, vol. 5, pp. 301-303, July 2001.
[19] S. Siwamogsatham and M. P. Fitz, “Improved High-Rate Space-Time Codes via Concatenation of Expanded Orthogonal Block Code and M-TCM,” Proceedings of 2002 ICC, vol. 1, pp. 636-640, May 2002.
[20] S. Siwamogsatham and M. P. Fitz, “Improved High-Rate Space-Time Codes via Orthogonality and Set Partitioning,” Proceedings of 2002 IEEE WCNC, vol. 1, pp. 264-270, March 2002.
[21] N. Seshadri and H. Jafarkhani, “Super-Orthogonal Space-Time Trellis Codes,” Proc. ICC '02, May 2002, Vol. 3, pp. 1439-1443.
[22] H. Jafarkhani, N. Seshadri, “Super-orthogonal space-time trellis codes,” IEEE Trans. Inform. Theory, vol. 49, pp. 937-950, April 2003.
[23] D. M. Ionescu and Z. Yan, “Fading-Resilient Super-Orthogonal Space-Time Signal Sets: Can Good Constellations Survive in Fading?,” submitted to IEEE Trans. Infom. Theory; available on the ArXiv server http://www.arxiv.org/abs/cs.IT/0505049
[24] 0. Tirkkonen and A. Hottinen, “Square-matrix embeddable space-time block codes for complex signal constellations,” IEEE Trans. Inform. Theory, vol. 48, pp. 384-395, February 2002.
[25] Z. Yan and D. M. Ionescu, “Geometrical Uniformity of a Class of Space-Time Trellis Codes,” IEEE Trans. Inform. Theory, vol. 50, pp. 3343-3347, December 2004.
[26] H. El Gamal, G. Caire, M. O. Damen, “Lattice coding and decoding achieve optimal diversity-multiplexing tradeoff of MIMO channels,” IEEE Trans. Inform. Theory, vol. 50, no. 6, pp. 968-985, June 2004.
[27] B. Hassibi and B. M. Hochwald, “High-rate codes that are linear in space and time,” IEEE Trans. Inform. Theory, vol. 48, no. 7, pp. 1804-1824, July 2002.
[28] B. Farhang-Boroujeny, Adaptive Filters: theory and applications. Chichester, West Sussex, England: Wiley, 2000.
[29] A. H. Banihashemi and F. R. Kschischang, “Tanner graphs for group block codes and lattices: construction and complexity,” IEEE Trans. Inform. Theory, vol. 47, February 2001
[30] M. C. Davey and D. MacKay, “Low-Density Parity Check Codes over GF(q),” IEEE Commun. Letters, vol. 2, June 1998
[31] E. Agrell, T. Eriksson, A. Vardy, and K. Zeger, “Closest point search in lattices,” IEEE Trans. Inform. Theory, vol. 48, No. 2, pp. 2201-2214, August 2002.
[32] S. Benedetto, D. Divsalar, G. Montorsi, and F. Pollara, “A soft-input soft-output APP module for iterative decoding of concatenated codes,” IEEE Commun. Lett., vol. 1, pp. 22-24, January 1997.
[33] L. R. Bahl, J. Cocke, F. Jelinek, and J. Raviv, “Optimal decoding of linear codes for minimizing symbol error rate,” IEEE Trans. Inform. Theory, vol. IT-20, pp. 284-287, March 1974.
[34] D. M. Ionescu, D. Doan, S. Gray, “On Interleaving Techniques for MIMO Channels and Limitations of Bit Interleaved Coded Modulation,” submitted to IEEE Trans. Infom. Theory; available on the ArXiv server http://www.arxiv.org/abs/cs.IT/0510072.

What is claimed is:

1. A method, comprising:
receiving a plurality of signals through a plurality of antennas, the plurality of signals being modulated with a space-time lattice code;
removing an effect of a channel matrix from the received signals to provide an equalized received signal; and
lattice detecting the equalized received signal based on a Tanner graph representation of the lattice.

2. The method of claim 1, where removing an effect of a channel matrix comprises iteratively removing cross-antenna interference.

3. The method of claim 1, where removing an effect of a channel matrix comprises operating a bank of finite impulse response (FIR) minimum mean square error (MMSE) filters to perform interference cancellation (IC).

4. The method of claim 1, where lattice detecting uses belief propagation on the lattice.

5. The method of claim 1, where lattice detecting comprises determining extrinsic a posterior probabilities (APPs) for candidate lattice points.

6. The method of claim 1, where the Tanner graph representation is one where lattice points inside a shaping region of interest are partitioned into a plurality of subgroups, each subgroup including a plurality of different lattice points and being labeled by an Abelian group block codeword, and where lattice detecting operates on the subgroups.

7. The method of claim 6, where the labels of all subgroups form an Abelian block code represented by the Tanner graph, and where lattice detecting comprises performing belief propagation on a corresponding non-binary label Tanner graph to yield a total a posterior probability (APP) and extrinsic APPs of the labels and their coordinates, and obtaining APPs of individual lattice points.

8. The method of claim 1, where lattice detecting comprises iteratively decoding between a single input/single output (SISO) a posterior probability (APP) module and a belief propagation module.

9. The method of claim 1, where lattice detecting comprises using a Markov process.

10. The method of claim 1, where lattice detecting comprises a step of initializing the lattice Tanner graph in one of a projection domain and a probability domain.

11. The method of claim 1, where a result of execution of lattice detecting comprises soft information concerning real coordinates of complex symbols from modulation constellations used on a plurality of transmit antennas.

12. The method of claim 1, executed in a receiver that is configured for use in a wireless communication device.

13. The method of claim 1, executed in a receiver adapted for use in a multiple input/multiple output (MIMO) system.

14. A computer program product embodied in a computer readable medium and comprising instructions, the execution of which result in performing operations that comprise:
in response to receiving a plurality of signals through a plurality of antennas, the plurality of signals being modulated with a space-time lattice code, removing an effect of a channel matrix from the received signals to provide an equalized received signal; and
lattice detecting the equalized received signal based on a Tanner graph representation of the lattice.

15. The computer program product of claim 14, where the operation of removing an effect of a channel matrix comprises iteratively removing cross-antenna interference.

16. The computer program product of claim 14, where the operation of removing an effect of a channel matrix comprises operating a bank of finite impulse response (FIR) minimum mean square error (MMSE) filters to perform interference cancellation (IC).

17. The computer program product of claim 14, where the operation of lattice detecting uses belief propagation on the lattice.

18. The computer program product of claim 14, where the operation of lattice detecting comprises determining extrinsic a posterior probabilities (APPs) for candidate lattice points.

19. The computer program product of claim 14, where the Tanner graph representation is one where lattice points inside a shaping region of interest are partitioned into a plurality of subgroups, each subgroup including a plurality of different lattice points and being labeled by an Abelian group block codeword, and where the operation of lattice detecting operates on the subgroups.

20. The computer program product of claim 19, where the labels of all subgroups form an Abelian block code represented by the Tanner graph, and where the operation of lattice detecting comprises performing belief propagation on a corresponding non-binary label Tanner graph to yield a total a posterior probability (APP) and extrinsic APPs of the labels and their coordinates, and an operation of obtaining APPs of individual lattice points.

21. The computer program product of claim 14, where the operation of lattice detecting comprises iteratively decoding between a single input/single output (SISO) a posterior probability (APP) module and a belief propagation (BP) module.

22. The computer program product of claim 14, where the operation of lattice detecting comprises using a Markov process.

23. The computer program product of claim 14, where the operation of lattice detecting comprises an operation of initializing the lattice Tanner graph in one of a projection domain and a probability domain.

24. The computer program product of claim 14, where the operation of lattice detecting comprises an operation of outputting soft information concerning real coordinates of complex symbols from modulation constellations used on a plurality of transmit antennas.

25. The computer program product of claim 14, executed in a receiver that is configured for use in a wireless communication device.

26. The computer program product of claim 14, executed in a receiver adapted for use in a multiple input/multiple output (MIMO) system.

27. An apparatus, comprising:
an equalizer configured to respond to a plurality of signals received through a plurality of receive antennas to remove an effect of a channel matrix from the received signals to provide an equalized received signal, the plurality of signals being transmitted from a plurality of transmit antennas modulated with a space-time lattice code; and
a detector configured to operate on the equalized received signal in accordance with a Tanner graph representation of the lattice to perform lattice detection and to output soft information concerning real coordinates of complex symbols from modulation constellations used at the plurality of transmit antennas.

28. The apparatus of claim 27, where said equalizer iteratively removes cross-antenna interference.

29. The apparatus of claim 27, where said equalizer comprises a bank of finite impulse response (FIR) minimum mean square error (MMSE) filters that perform interference cancellation (IC).

30. The apparatus of claim 27, where said detector comprises means for performing belief propagation on the lattice.

31. The apparatus of claim 27, where said detector comprises means for determining extrinsic a posterior probabilities (APPs) for candidate lattice points.

32. The apparatus of claim 27, where the Tanner graph representation is one where lattice points inside a shaping region of interest are partitioned into a plurality of subgroups, each subgroup including a plurality of different lattice points and being labeled by an Abelian group block codeword, and where said detector operates on the subgroups.

33. The apparatus of claim 32, where the labels of all subgroups form an Abelian block code represented by the Tanner graph, and where said detector comprises means for performing belief propagation on the Tanner graph to yield a total a posterior probability (APP) and extrinsic APPs of the labels and their coordinates, and means for obtaining APPs of individual lattice points.

34. The apparatus of claim 27, where said detector-comprises means for iteratively decoding between a single input/single output (SISO) a posterior probability (APP) module and a belief propagation (BP) module.

35. The apparatus of claim 27, where said detector uses a Markov process.

36. The apparatus of claim 27, where said detector initializes the lattice Tanner graph in one of a projection domain and a probability domain.

37. The apparatus of claim 27, configured for use in a wireless communication device.

38. The apparatus of claim 27, configured for use in an E-UTRAN wireless communication device.

39. The apparatus of claim 27, configured for use in an OFDM wireless communication device.

40. The apparatus of claim 27, configured for use in a receiver adapted to operate in a multiple input/multiple output (MIMO) system.

41. The apparatus of claim 27, embodied in at least one integrated circuit.

42. An integrated circuit, comprising:
an equalizer circuit configured to respond to a plurality of signals received through a plurality of receive antennas to remove an effect of a channel matrix from the received signals to provide an equalized received signal, the plurality of signals being transmitted from a plurality of transmit antennas modulated with a space-time lattice code; and
a detector circuit configured to operate on the equalized received signal in accordance with a Tanner graph representation of the lattice to perform lattice detection and to output soft information concerning real coordinates of complex symbols from modulation constellations used at the plurality of transmit antennas.

43. The integrated circuit of claim 42, where said equalizer circuit comprises a plurality of finite impulse response (FIR) minimum mean square error (MMSE) filters.

44. The integrated circuit of claim 42, where said detector circuit is configured to perform belief propagation on the lattice.

45. The integrated circuit of claim 42, where said detector circuit is configured to determine extrinsic a posterior probabilities (APPs) for candidate lattice points.

46. The integrated circuit of claim 42, where the Tanner graph representation is one where lattice points inside a shaping region of interest are partitioned into a plurality of subgroups, each subgroup including a plurality of different lattice points and being labeled by an Abelian group block codeword, where the labels of all subgroups form an Abelian block code represented by the Tanner graph, and where said detector circuit is configured to operate on the subgroups and to perform belief propagation on the Tanner graph to yield a total a posterior probability (APP) and extrinsic APPs of the labels and their coordinates.

47. The integrated circuit of claim 42, where said detector circuit comprises a single input/single output (SISO) a posterior probability (APP) module and a belief propagation (BP) module, is configured to iteratively decode between the SISO APP module and the BP module.

48. The integrated circuit of claim 42, where said detector circuit is configured to use a Markov process.

49. The integrated circuit of claim 42, where said detector circuit is configured to initialize the lattice Tanner graph in one of a projection domain and a probability domain.

50. The integrated circuit of claim 42, for use in a wireless communication device.

51. The integrated circuit of claim 42, for use in an E-UTRAN wireless communication device.

52. The integrated circuit of claim 42, for use in an OFDM wireless communication device.

53. Apparatus comprising:
means for equalizing a plurality of signals received through a plurality of receive antennas to remove an effect of a channel matrix from the received signals to provide an equalized received signal, the plurality of signals being transmitted from a plurality of transmit antennas modulated with a space-time lattice code; and
means for operating on the equalized received signal in accordance with a Tanner graph representation of the lattice to perform lattice detection and to output soft information concerning real coordinates of complex symbols from modulation constellations used at the plurality of transmit antennas.

54. The apparatus of claim 53, where said equalizing means comprises a plurality of finite impulse response (FIR) minimum mean square error (MMSE) filters.

55. The apparatus of claim 53, where the Tanner graph representation is one where lattice points inside a shaping region of interest are partitioned into a plurality of subgroups, each subgroup including a plurality of different lattice points and being labeled by an Abelian group block codeword, where the labels of all subgroups form an Abelian block code represented by the Tanner graph, and where said operating means is configured to operate on the subgroups and to perform belief propagation on the Tanner graph to yield a total a posterior probability (APP) and extrinsic APPs of the labels and their coordinates.

56. The apparatus of claim 53, where said operating means comprises a single input/single output (SISO) a posterior probability (APP) means and a belief propagation (BP) means, is configured to iteratively decode between the SISO APP means and the BP means.

57. The apparatus of claim 53, adapted for use in a wireless communications device.

58. The apparatus of claim 53, adapted for use in a receiver configured to operate in a multiple input/multiple output (MIMO) wireless communication system.
